(19) United States
(12) Patent Application Publication
(10) Pub. No.: US 2022/0335285 A1
(43) Pub. Date: Oct. 20, 2022

(54) METHODS, APPARATUS, AND ARTICLES OF MANUFACTURE TO IMPROVE PERFORMANCE OF AN ARTIFICIAL INTELLIGENCE BASED MODEL ON DATASETS HAVING DIFFERENT DISTRIBUTIONS

(71) Applicant: Intel Corporation, Santa Clara, CA (US)

(72) Inventors: Sairam Sundaresan, San Diego, CA (US); Souvik Kundu, Los Angeles, CA (US)

(21) Appl. No.: 17/853,518

(22) Filed: Jun. 29, 2022

(51) Int. Cl. G06N 3/063

(52) U.S. Cl. CPC G06N 3/063

(57) ABSTRACT

Methods, apparatus, systems, and articles of manufacture are disclosed to improve performance of an artificial intelligence based (AI-based) model on datasets having different distributions. An example apparatus includes interface circuitry to access data, computer readable instructions, and processor circuitry to at least one of instantiate or execute the computer readable instructions to implement adversarial evaluation circuitry, convolution circuitry, and output control circuitry. The example adversarial evaluation circuitry is to determine whether the data is to be processed as adversarial data. The example convolution circuitry is to, based on whether the data is to be processed as the adversarial data, determine a convolution of an input tensor and (1) a parameter tensor corresponding to a layer of the AI-based model or (2) a noisy parameter tensor generated based on the parameter tensor. The example output control circuitry is to output a classification of the data based on the convolution.

### FIELD OF THE DISCLOSURE

This disclosure relates generally to machine learning and, more particularly, to methods, apparatus, and articles of manufacture to improve performance of an artificial intelligence based model on datasets having different distributions.

### BACKGROUND

Machine learning models, such as neural networks, are useful tools that have demonstrated their value solving complex problems regarding pattern recognition, natural language processing, automatic speech recognition, etc. Neural networks operate, for example, using artificial neurons arranged into layers that process data from an input layer to an output layer. When processing data, weight values (sometimes referred to as weights) are applied to the data. Such weight values are determined during a training process. The number of layers in a neural network corresponds to a depth of the network, with more layers corresponding to a deeper network. Additionally, the number of channels (e.g., neurons) in a layer corresponds to the width of the layer, with more channels corresponding to a wider layer.

### BRIEF DESCRIPTION OF THE DRAWINGS

FIG. 1 is a block diagram of an example environment including an example machine learning platform and an example endpoint device.

FIG. 2 is a block diagram illustrating an example implementation of the machine learning platform of FIG. 1.

FIG. 3 is a block diagram illustrating an example implementation of the model execution circuitry of FIG. 2.

FIG. 4 is a block diagram illustrating an example layer of example neural networks disclosed herein.

FIGS. 5-8 are graphical illustrations comparing example performance metrics of (1) neural networks trained according to examples disclosed herein and (2) neural network trained according to other example techniques.

FIG. 9 is a flowchart representative of example machine readable instructions and/or example operations that may be executed and/or instantiated by example processor circuitry to implement the machine learning platform of FIGS. 1 and/or 2 to train a machine learning model to perform classification on datasets that may have different distributions.

FIG. 10 is a flowchart representative of example machine readable instructions and/or example operations that may be executed and/or instantiated by example processor circuitry to implement the model execution circuitry of FIGS. 2 and/or 3 to classify, during a training phase, data from datasets that may have different distributions.

FIG. 11 is a flowchart representative of example machine readable instructions and/or example operations that may be executed and/or instantiated by example processor circuitry to implement the model execution circuitry of FIGS. 2 and/or 3 to classify, during an inference phase, data from datasets that may have different distributions.

FIG. 12 is a block diagram of an example processing platform including processor circuitry structured to execute the example machine readable instructions and/or the example operations of FIGS. 9, 10, and/or 11 to implement the machine learning platform of FIGS. 1 and/or 2 and/or the model execution circuitry of FIGS. 2 and/or 3.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 9, 10, and/or 11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s). In some examples, an ASIC is referred to as Application Specific Integrated Circuitry.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model during a training process. For example, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase and an inference phase. In the learning/training phase, a training algorithm is used to train a model to operate in accordance with patterns and/or associations based on, for example, training data. For example, training data is data used to train a model to predict the outcome that the model is designed to predict. Training data may be marked and/or labelled with an expected outcome (e.g., an image of a dog in a training dataset is marked and/or labelled as “dog”). In general, the model includes internal parameters that guide how input data is transformed into output data, such as through a series of nodes and connections within the model to transform input data into output data (e.g., an output classification). Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

During training, internal parameters (sometimes referred to as parameters) of an ML model are tuned to reduce the difference between the pattern recognized by the ML model and the actual pattern represented in the input data. Many types of ML models exist. For example, popular ML models include regression (e.g., linear regression, logistic regression, etc.) models and neural network models (sometimes referred to as neural networks (NNs)). Parameters of ML models include the coefficients of a regression model and the weights of a NN.

After a model is trained, the trained model is deployed to operate in the inference phase to process data. In the inference phase, data to be analyzed (e.g., live data that has not been labelled) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes preprocessing before being used as an input to the machine learning model. Moreover, in some examples, the output data may undergo postprocessing after it is generated by the AI model to transform the output into a useful result (e.g., a display of data, an instruction to be executed by a machine, etc.).

NNs and/or other AI-based models are frequently used for many tasks. Such tasks may include image and video recognition, recommendation, image segmentation, image and video analysis, natural language processing, anomaly detection, time-series forecasting, etc. As AI-based models (e.g., NNs) are widely applicable, they are often adopted to perform computer vision (for example, in autonomous driving applications) which includes many tasks such as image and video recognition, image segmentation, and image and video analysis.

Despite the widespread adoption of AI-based models such as NNs, many still face difficulty when presented with perturbed inputs. A perturbed input (also referred to herein as an “adversarial” input) is an input that has been maliciously designed to alter (e.g., perturb) the input in a manner that is imperceptible to a human but changes the output of the AI-based model when processing the seemingly unchanged input. An unperturbed input (also referred to herein as a “clean” input) is an input that has not been altered. Such malicious actions are referred to as adversarial attacks. For example, a clean image that depicts a panda bear may be perturbed to create an adversarial image that, when processed by an image classification NN, is classified as an orangutan despite still depicting a panda bear. In some examples, adversarial inputs may be naturally occurring. For example, an image classification NN may nonetheless misclassify certain naturally occurring images despite having been trained to classify images with state-of-the-art (SOTA) accuracy.

Autonomous driving presents a more dangerous example of adversarial attacks. For example, a malicious entity may interfere with the physical presentation (e.g., paint, design, etc.) of a traffic sign to cause autonomous vehicles to capture an adversarial image of the traffic sign. Such adversarial images could be used to cause autonomous vehicles to operate incorrectly according to the rules of the road (e.g., to speed up at a stop sign, to drive above the posted speed limit, etc.) or otherwise interfere with autonomous driving (e.g., cause a vehicle to take an improper exit).

AI-based models (e.g., NNs) are frequently used to process images but are highly susceptible to adversarial images. As such, training an AI-based model may involve some amount of training on adversarial images so that the trained model will be robust against adversarial images when deployed. However, to attain robust performance on adversarial images, many example training approaches sacrifice performance on clean images, often resulting in a significant loss in performance (e.g., an NN will perform well when classifying adversarial images but perform poorly when classifying clean images).

Despite attempts to mitigate this unfavorable tradeoff, some training approaches suffer from increased training time, increased latency, and significant increase in storage requirements (e.g., during the training and inference phases) to produce models that can be tuned to perform at SOTA levels on clean images while also yielding SOTA robustness against adversarial attacks. For example, to improve model performance when processing adversarial images, various defense mechanisms may include hiding gradients, adding noise to parameters, and detecting malicious entities (e.g., adversaries). While some adversarial training approaches have proven to be consistently effective in achieving SOTA robustness, such approaches suffer many disadvantages.

For example, one example approach that achieves SOTA robustness is once-for-all adversarial training (OAT), which supports conditional learning to enable the network to adjust to different distributions of input data (e.g., clean images vs. adversarial images). In OAT, after each batch-normalization (BN) sub-layer of a model, a feature-wise linear modulation (FiLM) sub-layer executes. The weights of such FiLM sub-layer are controlled by a continuous conditional parameter. During an inference phase, the end-user sets the conditional parameter to adjust performance of the model, in operation, to trade-off between accuracy on clean images and robustness against adversarial attacks. However, the FiLM sub-layers utilized in the OAT approach increase the overall parameter count, training time, and network latency of such models and limit the applicability of such models in resource constrained, real time applications. Additionally, the accuracy of OAT trained models on clean images (sometimes referred to as clean accuracy (CA)) and the accuracy of OAT trained models on adversarial images (sometimes referred to as robust accuracy (RA)) is dependent (e.g., heavily dependent) on the choice of conditional parameter (e.g., the conditional hyperparameter) during training.

Other example approaches also suffer disadvantages. For example, some example approaches suffer from increased training time due to the additional overhead during backpropagation resulting from generating perturbed images, as well as additional storage requirements. For example, due to the CA-RA trade-off of processing both clean and adversarial images with the same lightweight model, some example approaches utilize multiple models or more complex larger models, which results in additional storage requirements to store the larger number of parameters for the model(s). Additionally, training approaches to provide adversarial defenses sometimes cause a significant drop in accuracy when a model is processing clean images.

Examples disclosed herein achieve SOTA robustness against adversarial data (both naturally occurring and maliciously generated attacks) while maintaining SOTA performance on clean data. For example, disclosed methods, apparatus, and articles of manufacture include fast learnable once-for-all adversarial training (FLOAT). FLOAT includes a configurable scaled noise tensor that is added to the parameter (e.g., weight) tensor for layers of the model when processing adversarial data. Additionally, example FLOAT disclosed herein simultaneously trains models using both clean and adversarial inputs. Examples disclosed herein also improve memory efficiency during training and/or inference by non-iteratively pruning parameters from the overall parameter count of a model. This approach is referred to as FLOAT Sparse (FLOATS). Although examples disclosed herein reference input images with respect to image classification, the input data may correspond to any type of input data for any task of an AI-based model.

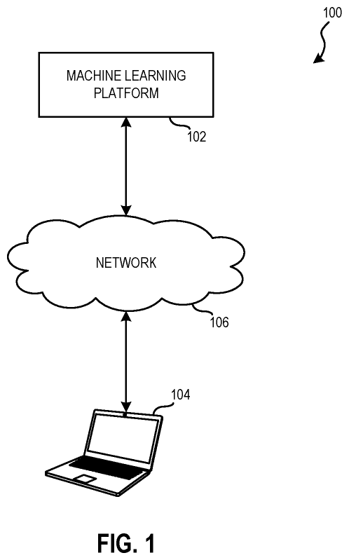

FIG. 1 is a block diagram of an example environment 100 including an example machine learning platform 102 and an example endpoint device 104. The example environment 100 includes the example machine learning platform 102, the example endpoint device 104, and an example network 106. In the example of FIG. 1, the example machine learning platform 102, the example endpoint device 104, and/or one or more additional devices are communicatively coupled via the example network 106.

In the illustrated example of FIG. 1, the machine learning platform 102 is implemented by a server executing instructions. In additional or alternative examples, the machine learning platform 102 is implemented by processor circuitry, analog circuit(s), digital circuit(s), logic circuit(s), programmable processor(s), programmable microcontroller(s), graphics processor unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). In the example of FIG. 1, the machine learning platform 102 executes a training algorithm to train an AI-based model, such as a convolutional NN (CNN) model, to classify input data from datasets having different distributions. For example, the machine learning platform 102 trains the CNN model to classify clean images that are from a first dataset having a first distribution and adversarial images that are from a second dataset having a second distribution, the second distribution different from the first distribution. In examples disclosed herein, a distribution is associated with a mean and a standard deviation. Two datasets have different distributions if the first dataset has at least one of a different mean or a different standard deviation from the second dataset.

Many different types of AI-based models, machine learning models, and/or machine learning architectures exist. In examples disclosed herein, a CNN model is used, as described above. Using a CNN model enables systems to achieve high performance on input data from datasets having different distributions. For example, clean image datasets and adversarial image datasets have different distributions. In general, AI-based models (e.g., machine learning models/architectures) may be used in example approaches disclosed herein, including neural networks, such as deep NNs (DNNs), and/or other models that are capable of operating in real time (e.g., with frequent data transfer between an endpoint device and an edge device and/or between an edge device and a cloud platform) in resource constrained environments. However, other types of AI or machine learning models could additionally or alternatively be used such as other models capable of classifying images or natural language processing models (e.g., statistical models, decision trees, hidden Markov models, transformer models), etc.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to including an expected output of the machine learning model (e.g., a classification, an expected output value, etc.) with the input. Additionally or alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent with backpropagation. For example, the backpropagation algorithm is used to compute gradients and the stochastic gradient descent algorithm is used to adjust parameters of ML/AI models. However, any other training algorithm may additionally or alternatively be used. In examples disclosed herein, training is performed for a threshold number of epochs known to be sufficient for a model to converge to a threshold amount of loss (e.g., a minimum error) determined by a loss function (e.g., a cross-entropy loss function). As used herein, an epoch refers to complete processing of training data by a machine learning model. In some examples, an early stop parameter is utilized to end training early in situations where the parameters of the model (e.g., the weights of the CNN) have converged to provide the threshold amount of loss prior to training for the threshold number of epochs. In some examples, the training is performed until a threshold accuracy of classification is achieved on datasets having different distributions (e.g., clean images and/or adversarial images).

In examples disclosed herein, training may be performed remotely (e.g., at a central facility of an entity providing the model to end-users) and/or locally (e.g., at a device that implements an AI-based model during the inference phase). Training is performed using hyperparameters that control how the learning is performed (e.g., a learning rate, a number of layers to be used in the machine learning model, etc.). In examples disclosed herein, during training, hyperparameters that control the learning rate, the model architecture, the number and sizes of batches of training data, the number of epochs, and compression of the amount of parameters (e.g., weights) of the model are used. During training, such hyperparameters are selected by, for example, a developer of the model. In examples disclosed herein, during inference, hyperparameters that bias performance of the model towards performance of the model on a dataset having a particular distribution (e.g., bias performance towards clean image datasets vs. adversarial image datasets) are used. Such inference hyperparameters include end-user defined hyperparameters and hyperparameters set by a developer of the model before the trained model is deployed.

In the illustrated example of FIG. 1, the machine learning platform 102 trains the CNN model to classify clean data (e.g., images) and adversarial data (e.g., images). In some examples, during training, the machine learning platform 102 reduces the total amount of parameters required to implement the CNN model by implementing pruning, as described further herein. In this manner, models trained by the machine learning platform 102 can operate in resource constrained environments (e.g., where there is a limited supply of resources, such as compute resources, memory resources, network resources, power resources, and/or storage resources). Additional detail of the machine learning platform 102 is discussed further herein.

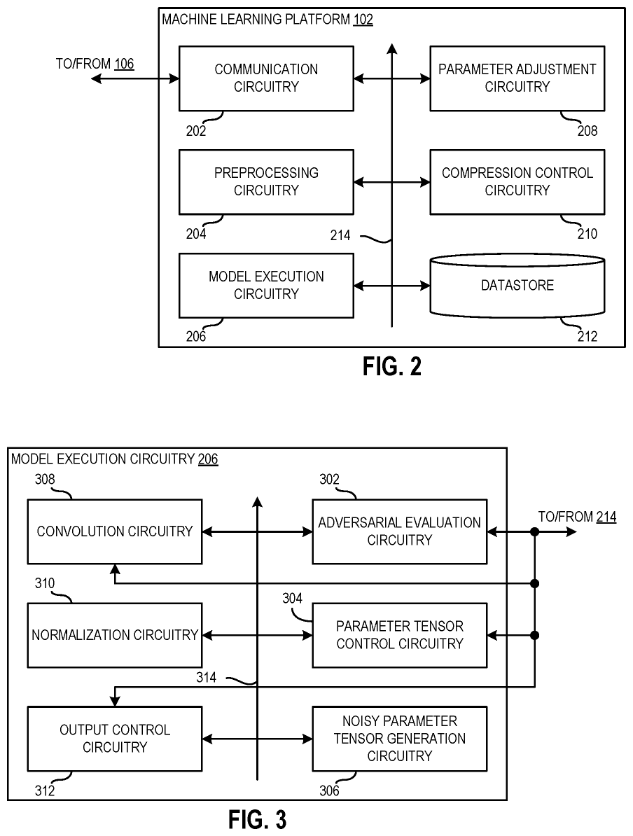

In the illustrated example of FIG. 1, the machine learning platform 102 offers one or more services and/or products to end-users. For example, the machine learning platform 102 provides one or more trained models for download/deployment, hosts a web-interface, among others. For example, if the machine learning platform 102 hosts a web-interface, an end-user operating the endpoint device 104 may request a model trained to accurately identify clean images and adversarial images. In some examples, the machine learning platform 102 provides end-users with a plugin that implements the machine learning platform 102. In this manner, the end-user can implement the machine learning platform 102 locally (e.g., at the endpoint device 104). The machine learning platform 102 is further described below in conjunction with FIG. 2.

In the illustrated example of FIG. 1, the endpoint device 104 is implemented by a laptop computer. In additional or alternative examples, the endpoint device 104 is implemented by a mobile phone, a tablet computer, a desktop computer, a server, among others, including processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. The endpoint device 104 can additionally or alternatively be implemented by a CPU, GPU, accelerator circuitry, or a heterogeneous system, among others. For example, the endpoint device 104 can be implemented as processor circuitry in an autonomous vehicle.

In the illustrated example of FIG. 1, the endpoint device 104 subscribes to, purchases, and/or otherwise accesses a product and/or service from the machine learning platform 102 to access one or more machine learning models trained to classify clean data and adversarial data. For example, the endpoint device 104 accesses the one or more trained models by downloading the one or more models as one or more executable files from the machine learning platform 102, accessing a web-interface hosted by the machine learning platform 102 and/or another device, among other techniques. In some examples, the endpoint device 104 installs one or more plugins to implement a machine learning application and/or other process. In such an example, the one or more plugins implement at least the machine learning platform 102.

In the illustrated example of FIG. 1, the network 106 is the Internet. However, the example network 106 may be implemented using any suitable wired and/or wireless network(s) including, for example, one or more data buses, one or more Local Area Networks (LANs), one or more wireless LANs, one or more cellular networks, one or more private networks, one or more public networks, etc. In additional or alternative examples, the network 106 is an enterprise network (e.g., within businesses, corporations, etc.), a home network, among others. The example network 106 enables the machine learning platform 102 and the endpoint device 104 to communicate.

FIG. 2 is a block diagram illustrating an example implementation of the machine learning platform 102 of FIG. 1. In the example of FIG. 2, the machine learning platform 102 includes example communication circuitry 202, example preprocessing circuitry 204, example model execution circuitry 206, example parameter adjustment circuitry 208, example compression control circuitry 210, and an example datastore 212. In the example of FIG. 2, any of the communication circuitry 202, the preprocessing circuitry 204, the model execution circuitry 206, the parameter adjustment circuitry 208, the compression control circuitry 210, and/or the datastore 212 can communicate via an example communication bus 214.

In the illustrated example of FIG. 2, the machine learning platform 102 may be instantiated (e.g., creating an instance of, bring into being for any length of time, materialize, implement, etc.) by processor circuitry such as a central processor unit executing instructions. Additionally or alternatively, the machine learning platform 102 of FIG. 2 may be instantiated (e.g., creating an instance of, bring into being for any length of time, materialize, implement, etc.) by an ASIC or an FPGA structured to perform operations corresponding to the instructions (e.g., operations corresponding to instructions). It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the illustrated example of FIG. 2, the machine learning platform 102 trains one or more ML models and/or executes one or more trained ML models. To train the one or more ML models, the machine learning platform 102 implements fast learnable once-for-all adversarial training (e.g., FLOAT), sparse fast learnable once-for-all adversarial training (e.g., FLOATS), and/or fast learnable once-for-all adversarial training with slimming (e.g., FLOAT slim). As described in further detail below, FLOATS may be implemented with (1) irregular sparsity (e.g., FLOATS-i) that prunes parameters from the overall parameter count of the model by applying a bitmask tensor to parameters within layers of the model and/or (2) channel sparsity (e.g., FLOATS-c) that prunes parameters from the overall parameter count of the model by applying a bitmask tensor to channels of the model on a per layer basis. Additionally, as described in further detail below, FLOAT slim may be implemented to prune parameters from the overall parameter count of the model by applying a bitmask tensor to channels of the model on a global basis.

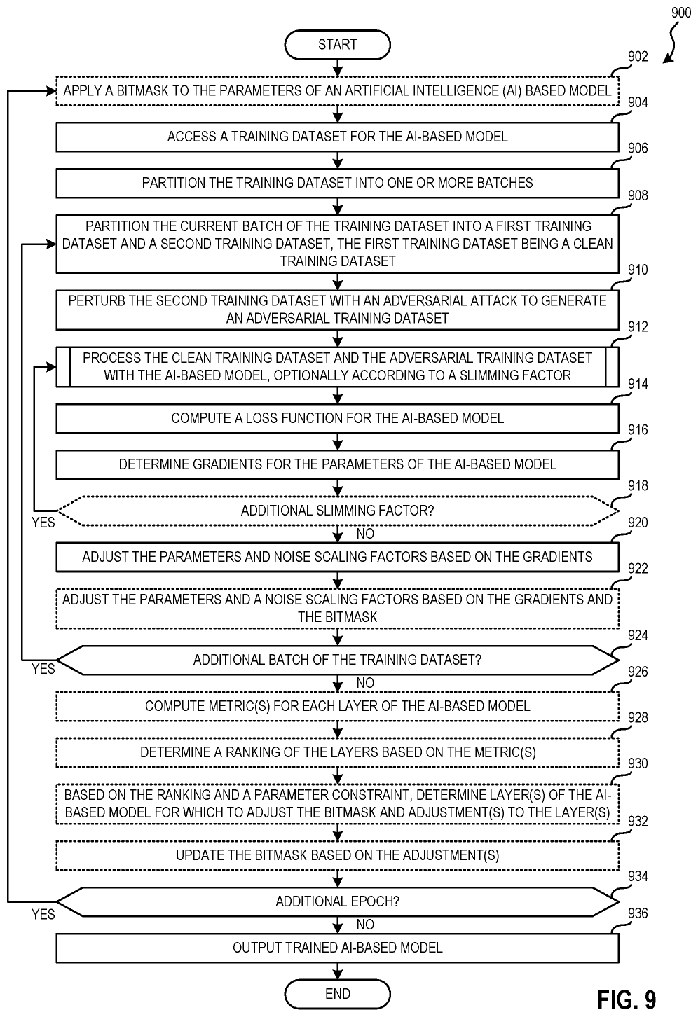

In the illustrated example of FIG. 2, the communication circuitry 202 controls communication between the machine learning platform 102 and other devices (e.g., connected directly and/or via the example network 106 of FIG. 1). For example, the communication circuitry 202 receives, obtains, and/or accesses packetized requests for a model and/or service from the endpoint device 104 and/or transmits, sends, and/or outputs packetized data representative of the model and/or output(s) from the model to the endpoint device 104. Additionally or alternatively, the communication circuitry 202 accesses data from the network 106. For example, the communication circuitry 202 accesses training data (e.g., to be used to train the model or models developed by the machine learning platform 102) from a local datastore (e.g., the datastore 212) and/or an external database. In examples disclosed herein, the training data originates from publicly available datasets. For example, publicly available datasets include the CIFAR-10 dataset, the CIFAR-100 dataset, the Tiny-ImageNet dataset, the SVHN dataset, and the STL10 dataset. In additional or alternative examples, a developer of the model may generate training data. In some examples, the communication circuitry 202 is instantiated by processor circuitry executing communication instructions and/or configured to perform operations such as those represented by the flowchart of FIG. 9.

In the illustrated example of FIG. 2, the preprocessing circuitry 204 preprocesses training data. For example, during each epoch of training, the preprocessing circuitry 204 partitions (e.g., divides, groups, etc.) a publicly available dataset into a training dataset and a validation dataset. In such examples, the preprocessing circuitry 204 partitions the training dataset into one or more batches. For each batch of the training dataset, the preprocessing circuitry 204 partitions the batch in half to form a first training dataset and a second training dataset where the first training dataset is a clean training dataset. For example, the preprocessing circuitry 204 randomly (e.g., pseudo-randomly) samples a batch of the training dataset to form the second training dataset. In the example of FIG. 2, the preprocessing circuitry 204 perturbs the images of the second training dataset with an adversarial attack to form an adversarial training dataset. For example, the preprocessing circuitry 204 perturbs the images of the second training dataset with a projected gradient descent (PGD) (e.g., PGD-k) adversarial attack. In general, perturbing input data includes altering, adjusting, transforming, and/or otherwise computing a variant of the input data. In the example of FIG. 2, the preprocessing circuitry 204 implements the below Equation 1 to perturb the images of the second training dataset.

\hat{x}^{k}=Proj_{P}_{_{ϵ}}₍ₓ₎(\hat{x}^{k-1}+σ×sign(∇ₓ [symbol] (ƒ_{Φ}(\hat{x}^{k-1},Θ;t)))) Equation 1

In Equation 1, ƒ_{Φ}( ) represents a function performed by a model executing an adversarial attack on an image x, Θ represents the parameters of the model executing the adversarial attack, t represents a label of the adversarial image \hat{x}^{k-1}, and k represents the dimension of the kernel used by the model executing the adversarial attack. In Equation 1, [symbol] ( ) represents a loss function for the model executing the adversarial attack, ∇ₓ represents a gradient of the loss function [symbol] ( ) with respect to the image x, sign represents a piecewise function that outputs a negative one, a zero, or a one depending on whether the input to the function is less than zero, equal to zero, or greater than zero, respectively, and a represents a step size of the adversarial attack. In Equation 1, P_{ϵ}(x) represents the projection space of the image x, E represents a perturbation constraint that determines the severity of the perturbation performed in the adversarial attack, and Proj represents a function that projects the adversarial image onto the projection space of the image x. In additional or alternative examples, different perturbation techniques may be used such as a Jacobian-based saliency map attack, a generative adversarial network attack, or a zeroth-order optimization attack, among others. In some examples, the adversarial training dataset may be a publicly available dataset of perturbed images.

As described above, in some examples, the preprocessing circuitry 204 preprocesses the publicly available dataset during each epoch of training to form a training dataset and a validation dataset. In some examples, the preprocessing circuitry 204 also preprocesses the validation dataset in a similar manner as describe above with respect to the training dataset. Because supervised training is used, the training data is labeled. In some examples, training data is labelled multiple times. For example, a first label, applied by a contributor to the publicly available dataset, identifies the scene depicted by an image (e.g., an image of a panda bear may be labeled “Panda”). Additionally, for example, a second label, applied by a developer of the model, identifies whether an image is clean or adversarial.

In some examples, the preprocessing circuitry 204 also preprocesses parameters of the ML model. For example, the parameters of the ML model may be represented by a tensor. To preprocess the parameters when implementing FLOATS, the preprocessing circuitry 204 applies a bitmask tensor to the parameter tensor for each layer of the model. For example, a bitmask tensor may be applied to a parameter tensor to reduce the number of non-zero parameters in the parameter tensor. The bitmask tensor includes binary elements (e.g., either one or zero in value) and is of the same dimensions as the parameter tensor. To apply the bitmask tensor to the parameter tensor, the preprocessing circuitry 204 performs element-wise multiplication using elements of the bitmask tensor and elements of the parameter tensor. As such, elements of the parameter tensor that are multiplied by zero value elements of the bitmask tensor will be zero (e.g., masked) in the resultant masked parameter tensor. In this manner, a bitmask tensor can be implemented for each layer of a model to reduce the overall number of parameters of a trained network. In some examples, the preprocessing circuitry 204 is instantiated by processor circuitry executing preprocessing instructions and/or configured to perform operations such as those represented by the flowchart of FIG. 9.

In the illustrated example of FIG. 2, the model execution circuitry 206 executes the model (e.g., the CNN) to process the clean training dataset and the adversarial training dataset. For example, the CNN is to classify the images of the clean training dataset and the adversarial training dataset. In the example of FIG. 2, the CNN model is an L-layer deep CNN that is parameterized by the set of parameters Θ to learn a function ƒ_{Φ}( ). For a classification task on a dataset X with distribution D, the model parameters Θ are learned by minimizing the empirical loss as shown in the below Equations 2, 3, and 4 below.

[symbol]

_{c}=(1−λ) [symbol] (ƒ_{Φ}(x,Θ;t)) Equation 2

[symbol]

_{A}=λ [symbol] (ƒ_{Φ}(\hat{x},Θ;t)) Equation 3

[symbol]

_{Total}=A [symbol] _{c}+B [symbol] _{A} Equation 4

In Equations 2-4, [symbol] _{c} represents the loss of the CNN when classifying clean images and [symbol] _{A} represents the loss of the CNN when classifying adversarial images. In Equations 2 and 3, x represents an input image to the CNN, Θ represents the weights of the CNN, t represents a label of the image x, \hat{x} represents a perturbed version of an image x, and λ represents a conditioning parameter. In Equation 4, [symbol] _{Total} represents the total loss of the CNN when classifying input images, A represents a coefficient of the clean loss, and B represents a coefficient of the adversarial loss. The coefficients of the clean and adversarial loss may be adjusted to control the relative contribution of the clean loss and the adversarial loss to the total loss of the CNN.

For each layer l of the CNN, the model parameters Θ are represented by a weight tensor θ^{l}. θ^{l} is a tuple of size kₕ^{l}×k_{w}^{l}×Cᵢ^{l}×Cₒ^{l} that includes real numbers (e.g., θ^{l}∈ [symbol] ^{k}^{ₕ}^{^{l}}^{×k}^{_{w}}^{^{l}}^{×C}^{ᵢ}^{^{l}}^{×C}^{ₒ}^{^{l}}). In examples disclosed herein, kₕ^{l} and k_{w}^{l} refer the height and width of the kernel k for the layer l, respectively. Cₒ^{l} refers to the number of filters per layer l and Cᵢ^{l} refers to the number of channels per filter of the layer l. In the example of FIG. 2, the height and width of the kernel are the same and may be referred to interchangeably as k^{l}.

The conditioning parameter (λ) controls whether the CNN processes an input image as a clean image or an adversarial image. During training, the model execution circuitry 206 executes the CNN with a binary conditioning parameter (λ). For example, when the binary conditioning parameter (λ) is equal to zero, the model execution circuitry 206 processes an input image as a clean image, and when the binary conditioning parameter (λ) is equal to one, the model execution circuitry 206 processes an input image as an adversarial image. By implementing a binary conditioning parameter (λ), examples disclosed herein reduce the search space when training the CNN, thereby decreasing training time and resources consumed during training. For example, approaches that utilize a continuous conditioning parameter must train over a larger search space which increases training time and resources expended during training.

Additionally, in the example of FIG. 2, when processing adversarial images, the model execution circuitry 206 augments the weight tensor θ^{l} with a noise tensor η^{l} that is scaled by a noise scaling factor α^{l} to generate a noisy weight tensor \hat{θ}^{l}. In the example of FIG. 2, the noise scaling factor α^{l} is a scalar value applied to each parameter value of the layer l. In some examples, a noise scaling tensor α^{l} may be utilized where different scaling factors are applied to each parameter value of the layer l. The noise tensor η^{l} is a tuple of size k^{l}×k^{l}×Cᵢ^{l}×Cₒ^{l} that includes real numbers (e.g., η^{l}∈ [symbol] ^{k}^{^{l}}^{×k}^{^{l}}^{×C}^{ᵢ}^{^{l}}^{×C}^{ₒ}^{^{l}}). The model execution circuitry 206 generates the noise tensor η^{l} according to a normal distribution with a mean of zero and a standard deviation of σ^{l}. In the example of FIG. 2, the standard deviation σ^{l} of the noise tensor η^{l} is equivalent to the standard deviation of the weight tensor θ^{l}. To generate the noisy weight tensor \hat{θ}^{l}, the model execution circuitry 206 implements the below Equation 5.

\hat{θ}^{l}=θ^{l}+λ·α^{l}·η^{l};η^{l}˜N(0,(σ^{l})²) Equation 5

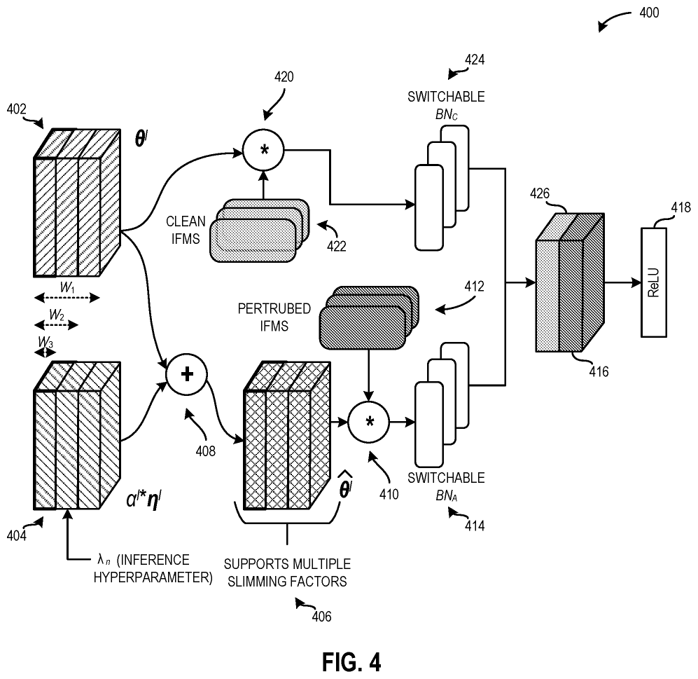

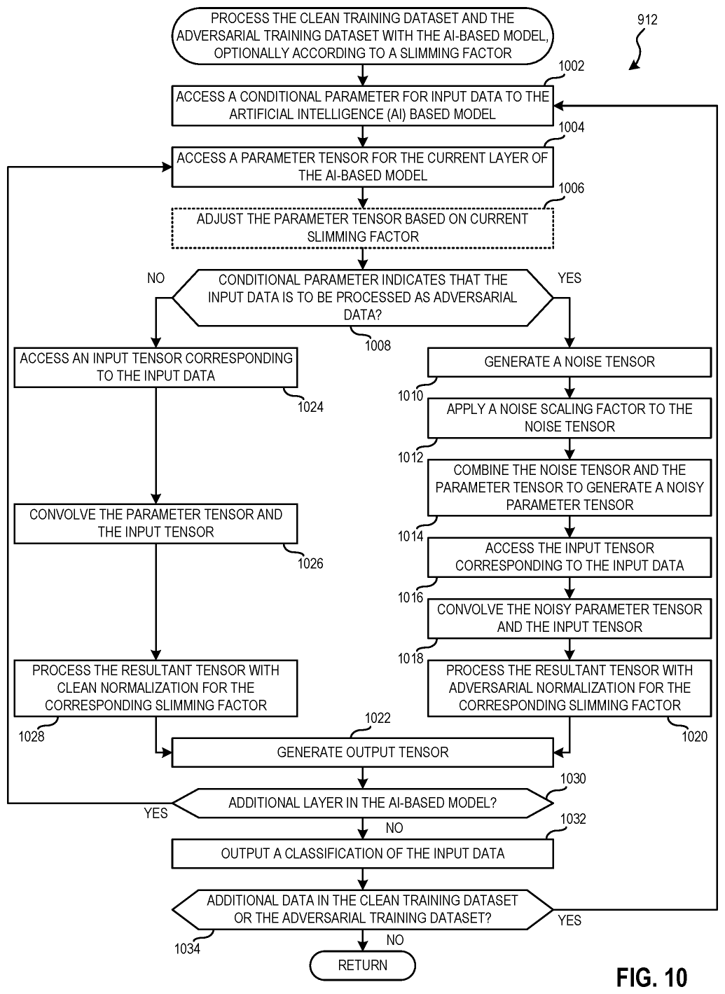

In some examples, when the machine learning platform 102 implements FLOAT slim, the model execution circuitry 206 implements slimming to reduce the width of layer(s) of the model across the whole model (e.g., on a global scale). For example, FLOATS slim trains a model with channel widths that are scaled by a global channel slimming factor (SF). Unlike FLOATS-c, where different layers might have different SFs, FLOAT slim and/or FLOATS slim (discussed further below) yields uniform SFs for all layers of a model. For example, a model trained according to FLOAT slim with an SF less than one is trained as a shared-weight sub-network of the model with an SF equal to one. This approach contrasts FLOATS-c, where only one model having a specific global parameter density d is trained. In some examples, the model execution circuitry 206 is instantiated by processor circuitry executing model instructions and/or configured to perform operations such as those represented by the flowcharts of FIGS. 9, 10, and/or 11. FIG. 3 is a block diagram illustrating an example implementation of the model execution circuitry 206 of FIG. 2.

FIG. 3 is an example block diagram of the model execution circuitry 206 of FIG. 2. The example model execution circuitry 206 of FIG. 2 includes example adversarial evaluation circuitry 302, example parameter tensor control circuitry 304, example noisy parameter tensor generation circuitry 306, example convolution circuitry 308, example normalization circuitry 310, and example output control circuitry 312. In the example of FIG. 3, any of the adversarial evaluation circuitry 302, the parameter tensor control circuitry 304, the noisy parameter tensor generation circuitry 306, the convolution circuitry 308, the normalization circuitry 310, and/or the output control circuitry 312 can communicate via an example communication bus 314.

In examples disclosed herein, the model execution circuitry 206 executes an AI-based model and/or ML model (e.g., the CNN) during training and inference. The example model execution circuitry 206 of FIGS. 2 and/or 3 may be instantiated (e.g., creating an instance of, bring into being for any length of time, materialize, implement, etc.) by processor circuitry such as a central processor unit executing instructions. Additionally or alternatively, the model execution circuitry 206 of FIGS. 2 and/or 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

In the illustrated example of FIG. 3, the adversarial evaluation circuitry 302 evaluates whether the input image to the model should be processed as a clean image or an adversarial image. For example, during training, the adversarial evaluation circuitry 302 accesses the conditional parameter (λ) and determines (e.g., makes a determination of) whether the conditional parameter indicates that the input image is to be processed as an adversarial image. For example, during training, in response to the conditional parameter (λ) being zero, the adversarial evaluation circuitry 302 determines that the input image is to be processed as a clean image. Alternatively, for example, in response to the conditional parameter (λ) being one, the adversarial evaluation circuitry 302 determines that the input image is to be processed as an adversarial image.

In the illustrated example of FIG. 3, during inference, the adversarial evaluation circuitry 302 accesses a conditional rescaling parameter (λₙ) and determines whether the conditional rescaling parameter indicates that the input image is to be processed as an adversarial image. For example, during inference, in response to the adversarial evaluation circuitry 302 determining that the conditional rescaling parameter (λₙ) satisfies a condition threshold (λₜₕ), the adversarial evaluation circuitry 302 determines that the input image is to be processed as an adversarial image. In response to the adversarial evaluation circuitry 302 determining that the conditional rescaling parameter (λₙ) does not satisfy the condition threshold (λₜₕ), the adversarial evaluation circuitry 302 determines that the input image is to be processed as a clean image.

In the illustrated example of FIG. 3, the conditional rescaling parameter (λₙ) satisfies the condition threshold (λₜₕ) when the conditional rescaling parameter (λ) exceeds the condition threshold (λₜₕ) (e.g., λₙ>λₜₕ). In additional or alternative examples different criteria for satisfying the condition threshold (λₜₕ) may be used. For example, in some implementations, the conditional rescaling parameter (λₙ) may be considered to satisfy the condition threshold (λₜₕ) when the conditional rescaling parameter (λₙ) is greater than or equal to, less than, less than or equal to, or equal to the condition threshold (λₜₕ).

In the illustrated example of FIG. 3, the conditional rescaling parameter (λₙ) is an end-user defined value ranging from zero to one that allows an end-user to bias performance of the trained model towards accuracy on clean images or robustness against adversarial attacks (e.g., to move the performance of the model along the CA-RA trade-off curve as discussed further below) subject to the condition threshold (λₜₕ). For example, an end-user provides the conditional rescaling parameter (λₙ) on a per-inference basis. In additional or alternative examples, an end-user provides the conditional rescaling parameter (λₙ) once and the conditional rescaling parameter (λₙ) is used until the end-user changes again. In such examples, an end-user can dynamically switch between better performance when classifying clean images and better performance when classifying adversarial images. As such, examples disclosed herein provide end-users with more flexibility if they are not confident about which condition (e.g., adversarial or clean) to use during inference.

In the illustrated example of FIG. 3, the condition threshold (λₜₕ) is a value ranging from zero to one that is set by a developer of the model. As such, the condition threshold (λₜₕ) allows a developer of the model to inherently bias performance of the trained model towards accuracy on clean images or robustness against adversarial attacks. For example, by setting a non-zero condition threshold (λₜₕ), a developer of the model inherently biases the performance of the trained model to classify adversarial images more accurately. Additionally, as discussed further below, the condition threshold (λₜₕ) allows the model to dynamically select between at least one batch-normalization sub-layer that is dedicated for adversarial processing and at least one batch-normalization sub-layer that is dedicated clean processing. In some examples, the adversarial evaluation circuitry 302 is instantiated by processor circuitry executing adversarial evaluation instructions and/or configured to perform operations such as those represented by the flowcharts of FIGS. 10 and/or 11.

In the illustrated example of FIG. 3, the parameter tensor control circuitry 304 accesses, obtains, and/or receives a parameter tensor for the current layer of the model. For example, the parameter tensor control circuitry 304 accesses a weight tensor θ^{l} for the current layer of the CNN. If the machine learning platform 102 is implementing FLOAT slim, the parameter tensor control circuitry 304 adjusts the parameter tensor based on the selected slimming factor (SF). In such examples, for a set S_{ƒ} of SFs w where w is between zero and one (e.g., w∈(0,1]), the parameter tensor control circuitry 304 reduces the number of active channels of the weight tensor θ^{l} for the current layer of the CNN by applying a bitmask tensor to the channels of the weight tensor θ^{l}. For example, if the weight tensor θ^{l} includes four channels and the slimming factor is 0.5, the parameter tensor control circuitry 304 applies a bitmask tensor to reduce the number of active channels of the weight tensor θ^{l} from four to two. In some examples, the parameter tensor control circuitry 304 is instantiated by processor circuitry executing parameter tensor control instructions and/or configured to perform operations such as those represented by the flowcharts of FIGS. 10 and/or 11.

In the illustrated example of FIG. 3, the noisy parameter tensor generation circuitry 306 operates when an input image is to be processed as an adversarial image. In the example of FIG. 3, the noisy parameter tensor generation circuitry 306 generates a noisy parameter tensor based on the parameter tensor. For example, the noisy parameter tensor generation circuitry 306 accesses the weight tensor θ^{l} and generates a noise tensor η^{l} to apply to the weight tensor θ^{l}. The noisy parameter tensor generation circuitry 306 generates the noise tensor η^{l} according to a normal distribution with a mean of zero and a standard deviation of σ^{l}. In additional or alternative examples, the noisy parameter tensor generation circuitry 306 generates the noise tensor Θ^{l} in any other suitable manner.

In the illustrated example of FIG. 3, during training, the noisy parameter tensor generation circuitry 306 applies a noise scaling factor α^{l} for the layer l to the noise tensor η^{l} for the layer l. For example, the noisy parameter tensor generation circuitry 306 multiplies the noise tensor η^{l} by the noise scaling factor α^{l}. During inference, the noisy parameter tensor generation circuitry 306 applies a noise scaling factor α^{l} for the layer l and the conditional rescaling parameter (λₙ) to the noise tensor η^{l} for the layer l. For example, the noisy parameter tensor generation circuitry 306 multiplies the noise tensor η^{l} by the noise scaling factor α^{l} and the conditional rescaling parameter (λₙ).

In the illustrated example of FIG. 3, the noisy parameter tensor generation circuitry 306 subsequently combines (e.g., adds) the noise tensor η^{l} with the weight tensor θ^{l} to generate the noisy weight tensor \hat{θ}^{l} (e.g., combine the noise tensor with the parameter tensor to generate the noisy parameter tensor). The noisy parameter tensor generation circuitry 306 may be implemented according to Equation 5 above.

In some examples, the noisy parameter tensor generation circuitry 306 of FIG. 3 may be implemented by in-memory compute circuitry and/or near-memory compute circuitry. In such examples, data movement will be reduced which also ensures that latency does not increase. Additionally or alternatively, a look up table (LUT) storing different noise tensors may be positioned physically proximate to the noisy parameter tensor generation circuitry 306. In such examples, latency is reduced as the noise values are not accessed from an external memory such as Dynamic Random-Access Memory (DRAM). In some examples, the noisy parameter tensor generation circuitry 306 is instantiated by processor circuitry executing noisy parameter tensor generation instructions and/or configured to perform operations such as those represented by the flowcharts of FIGS. 10 and/or 11.

In the illustrated example of FIG. 3, the convolution circuitry 308 operates differently based on whether the conditional parameter (λ) indicates that input data is to be processed as adversarial data or clean data. For example, based on whether the conditional parameter indicates that the input image is to be processed as an adversarial image, the convolution circuitry 308 convolves an input tensor corresponding to the input image with the parameter tensor corresponding to the layer of the model or the noisy parameter tensor generated based on the parameter tensor. When an image is to be processed as a clean image, the convolution circuitry 308 convolves the input tensor corresponding to the input image with the parameter tensor corresponding to the layer of the model. When an image is to be processed as an adversarial image, the convolution circuitry 308 convolves the input tensor corresponding to the input image with the noisy parameter tensor that was generated based on the parameter tensor for the corresponding layer of the model. In some examples, the convolution circuitry 308 is instantiated by processor circuitry executing convolution instructions and/or configured to perform operations such as those represented by the flowcharts of FIGS. 10 and/or 11.

In the illustrated example of FIG. 3, the normalization circuitry 310 implements two or more batch-normalization sub-layers. For example, the normalization circuitry 310 includes at least one batch-normalization sub-layer (e.g., BN_{C}) with which to process the resultant tensor output from the convolution circuitry 308 when processing an image as a clean image. Additionally, for example, the normalization circuitry 310 includes at least one batch-normalization sub-layer (e.g., BN_{A}) with which to process the resultant tensor output from the convolution circuitry 308 when processing an image as an adversarial image.

When the machine learning platform 102 implements FLOAT slim, the normalization circuitry 310 also includes additional batch-normalization sub-layers corresponding to each slimming factor. For example, if three slimming factors are utilized, the normalization circuitry 310 includes three batch-normalization sub-layers with which to process tensors when processing an image as an adversarial image (e.g., BN_{A}) and three batch-normalization sub-layers with which to process tensors when processing an image as a clean image (e.g., BN_{C}). In operation, the normalization circuitry 310 process the resultant tensor output from the convolution circuitry 308 with the batch-normalization sub-layer corresponding to the current slimming factor (e.g., for the corresponding slimming factor). In some examples, the normalization circuitry 310 is instantiated by processor circuitry executing normalization instructions and/or configured to perform operations such as those represented by the flowcharts of FIGS. 10 and/or 11.

In the illustrated example of FIG. 3, the output control circuitry 312 generates an output tensor for the current layer of the model. For example, the output control circuitry 312 applies a non-linear activation function to the tensor output from the normalization circuitry 310 to generate the output tensor for the current layer of the model. For example, the output control circuitry 312 applies the rectified linear (ReLU) activation function to the tensor output from the normalization circuitry 310 to generate the output tensor for the current layer of the model. In additional or alternative examples, different non-linear activation functions may be used. If the current layer of the model is the last layer, the output control circuitry 312 also outputs a classification of an input image to the model. In some examples, the output control circuitry 312 is instantiated by processor circuitry executing output control instructions and/or configured to perform operations such as those represented by the flowcharts of FIGS. 10 and/or 11.

Returning to FIG. 2, after the model execution circuitry 206 processes the clean training dataset and the adversarial training dataset with the model, the example parameter adjustment circuitry 208 computes a loss function for the model. For example, the parameter adjustment circuitry 208 implements the above Equations 2, 3, and 4 to determine the cross-entropy loss of CNN model during training. The parameter adjustment circuitry 208 determines one or more gradients for the parameters of the CNN model, for example, using the backpropagation algorithm. The parameter adjustment circuitry 208 adjusts the parameters of the CNN model and the noise scaling factors of the CNN model based on the gradients. Accordingly, the noise scaling factors are trainable and the magnitude of individual noise scaling factors can be different for each layer (for example, to minimize the total training loss).

For example, the parameter adjustment circuitry 208 adjusts the parameters and the noise scaling factors of the CNN model using stochastic gradient descent. In some examples, when the machine learning platform 102 implements FLOATS, the parameter adjustment circuitry 208 adjusts the parameters of the CNN model and the noise scaling factors of the CNN model based on the gradients and the bitmask for the CNN model. In some examples, the parameter adjustment circuitry 208 is instantiated by processor circuitry executing parameter adjustment instructions and/or configured to perform operations such as those represented by the flowchart of FIG. 9.

In the illustrated example of FIG. 2, the compression control circuitry 210 operates when the machine learning platform 102 implements FLOATS to prune parameters from the model during training. Pruning is a form of model compression that is effective in reducing model size and computation complexity for large NNs (e.g., DNNs) that are to be deployed in resource-constrained environments. To implement pruning, the example compression control circuitry 210 computes one or more metrics for each layer of the ML model. The compression control circuitry 210 ranks the layers of the ML model based on the metrics for the layers. To facilitate sparsity (e.g., a tensor including many zero value elements and/or elements with values that do not significantly impact calculation) in the parameters of the model, the compression control circuitry 210 determines (a) which layers of the model for which to adjust the bitmask tensor and (b) adjustments to be made to the determined layers. Adding sparsity to the parameters of an AI-based model allows the developer to reduce the storage requirements for the model when deployed. For example, the zero values of the parameters may be removed from the parameters when stored and added back to the parameters during execution through the use of a bitmap that includes one-bit elements identifying whether respective elements of the parameter tensor are zero or non-zero.

In the illustrated example of FIG. 2, the compression control circuitry 210 determines the layers to be adjusted and the adjustments to make to the layers based on the ranking of the layers and a parameter constraint. The parameter constraint is associated with the total cardinality of the masked parameters of the model. The parameter constraint is illustrated in the below Equation 6.

$${\sum }_{l = 1}^{L} card ( {θ}^{l} ⊙ {π}^{l} ) \leq d {\sum }_{l = 1}^{L} card ( {θ}^{l} ) \qquad Equation 6$$

In Equation 6, θ^{l} represents the parameter tensor for the layer l, π^{l} represents the bitmask tensor for the parameters for the layer l, card represents a function that returns the cardinality of an input, and ⊙ represents the element-wise multiplication operator. As described above, FLOATS may be implemented with irregular sparsity (e.g., FLOATS-i) and/or channel sparsity (e.g., FLOATS-c). FLOATS not only improves model performance on both clean and adversarial images (e.g., improves the CA-RA trade-off), but also meets a target global parameter density d for the model. For example, the target global parameter density d for the model is based on the resources of an expected deployment environment of the model and/or the expected runtime characteristics of the expected deployment environment. For example, the expected deployment environment may be an edge device that has limited resources (e.g., compute, power, memory, storage, etc.) and, during runtime, many of the limited resources may be occupied with operations associated with other services offered by the edge device.

With respect to FLOATS-i, for layer(s) of the model, the compression control circuitry 210 computes the normalized momentum of the non-zero parameters in the corresponding layer(s). The compression control circuitry 210 ranks the layers of the model based on the normalized momentum of the corresponding layer. For example, the compression control circuitry 210 ranks the layers of the model from highest momentum to lowest momentum. Based on the ranking and the parameter constraint, the compression control circuitry 210 dynamically allocates more weights to layers that have higher momentum and fewer weights to other layers, while maintaining the global parameter density constraint.

For example, after ranking the layers of the model, the compression control circuitry 210 determines the number of zeros to add to a binary bitmask for the parameters of the model based on a prune rate for training (e.g., 25-30% of the bitmask). In the example of FIG. 2, the bitmask is parameterized by the set of parameters Π. In examples disclosed herein, the set of parameters Π of the bitmask may be referred to as the bitmask Π. In the example of FIG. 2, the number of zeros to add to the bitmask represents the number of connections to deactivate in the model. Additionally, for a threshold number (e.g., 10) of the lowest ranked layers, the compression control circuitry 210 determines which weights to prune based on the individual contribution of the weights to the momentum of the layer. For example, for a bitmask tensor π^{l} layer l, the fraction of ones in the bitmask tensor π^{l} is proportional to the relative rank of the layer when evaluated through momentum.

In the illustrated example of FIG. 2, the compression control circuitry 210 adjusts the bitmask Π based on the momentums of the layers of the model. For example, the compression control circuitry 210 then adds ones to the layers of the bitmask Π that have higher ranked momentums and adds zeros to the layers of the bitmask Π that have lower ranked momentums. In this manner, the compression control circuitry 210 effectively deactivates connections in layers of the model that have lower momentum while activating connections in layers of the model that have higher momentum.

With respect to FLOATS-c, for each layer of the model, the compression control circuitry 210 computes the Frobenius norm (F-norm). To compute the F-norm, the compression control circuitry 210 converts the four-dimensional parameter tensor θ^{l} to a two-dimensional parameter matrix with Cₒ^{l} rows and (k^{l})²Cᵢ^{l} columns. The compression control circuitry 210 may also subdivide the two-dimensional parameter matrix into Cᵢ^{l} sub-matrices with Cₒ^{l} rows and (k^{l})² columns. The compression control circuitry 210 computes the F-norm for each of the Cᵢ^{l} sub-matrices according to the below Equation 7.

ƒ_{c}^{l}=∥θ_{:,c,:,:}^{l}∥_{F}² Equation 7

In the illustrated example of FIG. 2, the compression control circuitry 210 ranks the layers of the model based on the F-norm values. For example, the compression control circuitry 210 ranks the layers of the model from highest F-norm value to lowest F-norm value. Based on the ranking and the parameter constraint, the compression control circuitry 210 dynamically allocates more weights to layers that have higher F-norm values and fewer weights to other layers, while maintaining the global parameter density constraint. In this manner, FLOATS-c allows for pruning to be done at the channel level. In some examples, the compression control circuitry 210 is instantiated by processor circuitry executing compression control instructions and/or configured to perform operations such as those represented by the flowchart of FIG. 9.

In the illustrated example of FIG. 2, after training is complete, the model is deployed for use as an executable construct that processes an input and provides an output based on the network of nodes and connections defined in the model. In some examples, the model is provided as a service (e.g., at the edge, in the cloud, and/or via the web) by the developer of the model. In other examples, the developer of the model may provide the model as an executable that an end-user can download to an endpoint device. In general, the parameters (e.g., weights) of the model are stored in a datastore of the device that is to execute the model (e.g., the datastore 212 and/or a datastore of the endpoint device 104). However, in some examples, parameters (e.g., weights) of the model may be streamed to the device executing the model (e.g., on a per-layer basis) as the model executes.

In the illustrated example of FIG. 2, the datastore 212 is configured to store data. For example, the datastore 212 can store one or more files indicative of one or more trained CNN models, parameters Θ corresponding to the one or more trained CNN models, noise scaling factors corresponding to the one or more trained CNN models, bitmasks Π corresponding to the one or more trained CNN models, one or more datasets for training the CNN model(s), and/or other values related to the training phase and/or inference phase. In the example of FIG. 2, the datastore 212 may be implemented by a volatile memory (e.g., a Synchronous Dynamic Random-Access Memory (SDRAM), DRAM, RAMBUS Dynamic Random-Access Memory (RDRAM), etc.) and/or a non-volatile memory (e.g., flash memory). The example datastore 212 may additionally or alternatively be implemented by one or more double data rate (DDR) memories, such as DDR, DDR2, DDR3, DDR4, mobile DDR (mDDR), etc.

In additional or alternative examples, the example datastore 212 may be implemented by one or more mass storage devices such as hard disk drive(s), compact disk drive(s), digital versatile disk drive(s), solid-state disk drive(s), etc. While in the illustrated example the datastore 212 is illustrated as a single database, the datastore 212 may be implemented by any number and/or type(s) of databases. Furthermore, the data stored in the datastore 212 may be in any data format such as, for example, binary data, comma delimited data, tab delimited data, structured query language (SQL) structures, etc.

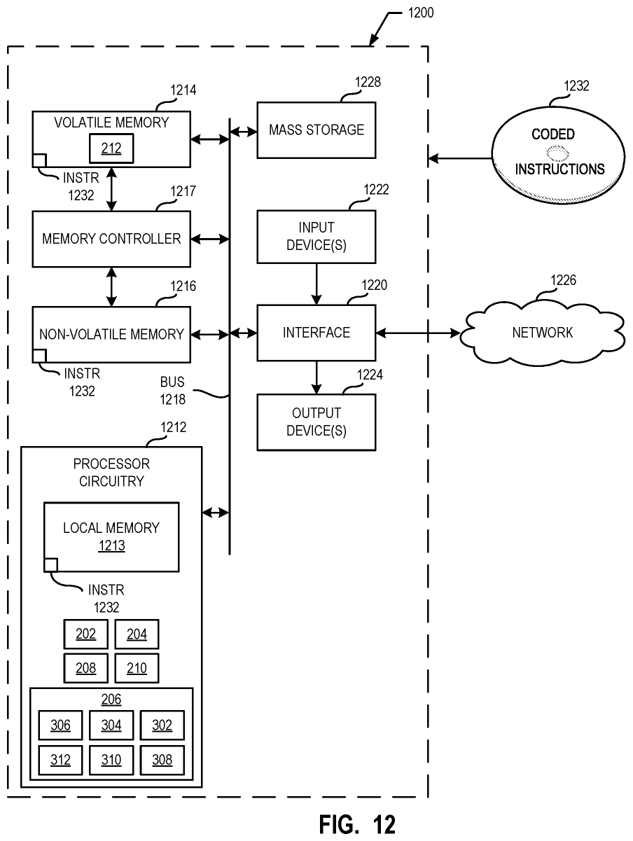

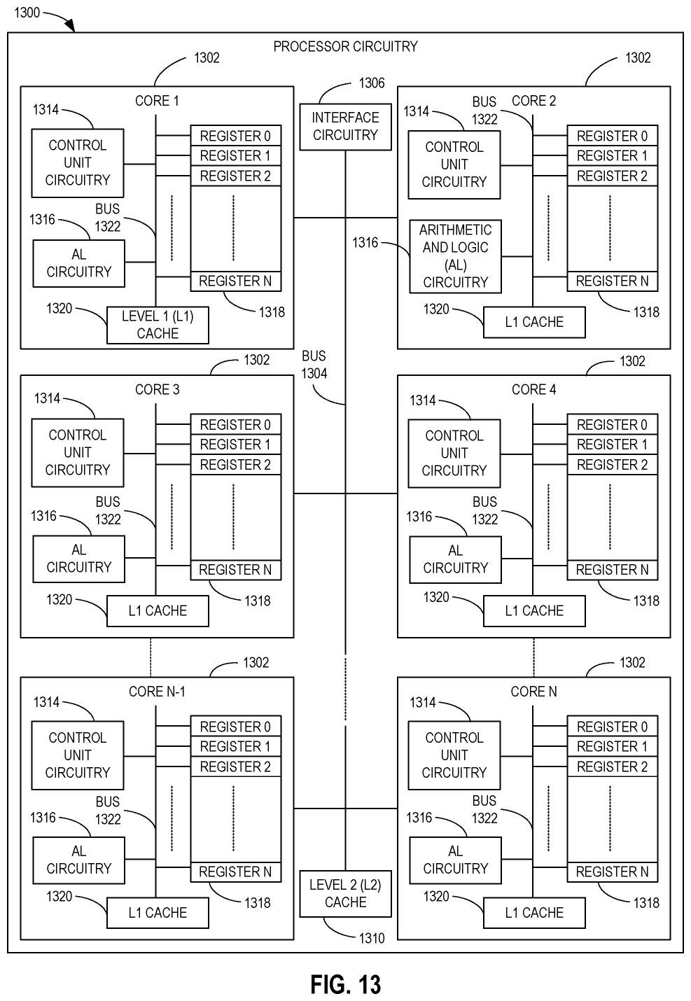

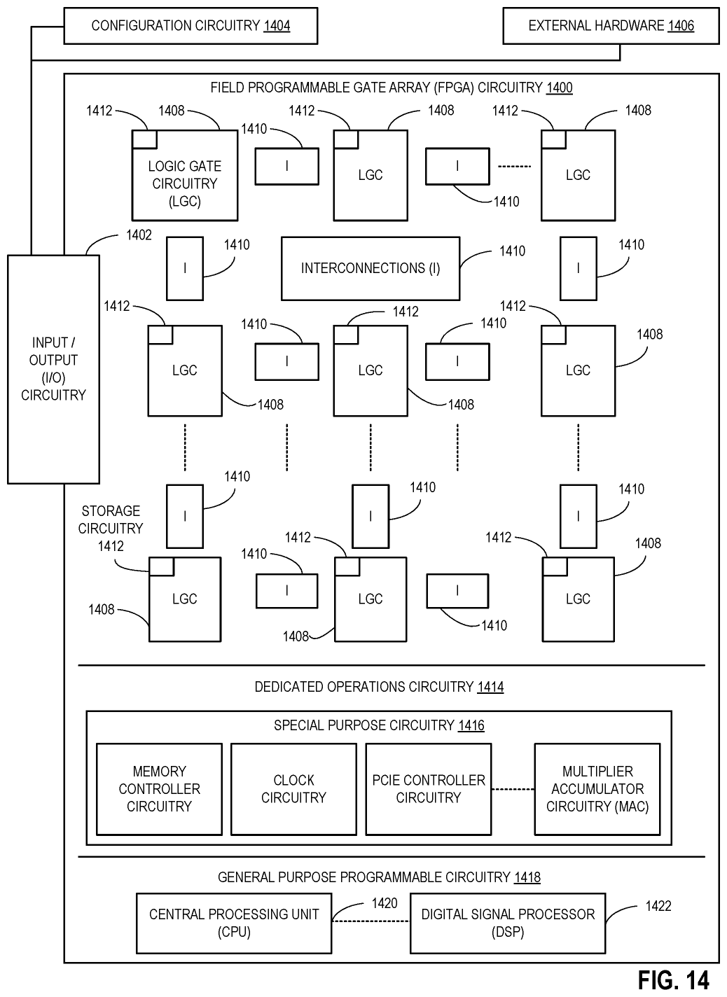

In some examples, the machine learning platform 102 includes means for accessing. For example, the means for accessing may be implemented by the communication circuitry 202. In some examples, the communication circuitry 202 may be instantiated by processor circuitry such as the example processor circuitry 1212 of FIG. 12. For instance, the communication circuitry 202 may be instantiated by the example microprocessor 1300 of FIG. 13 executing machine executable instructions such as those implemented by at least block 904 of FIG. 9. In some examples, the communication circuitry 202 may be instantiated by hardware logic circuitry, which may be implemented by an ASIC, XPU, or the FPGA circuitry 1400 of FIG. 14 structured to perform operations corresponding to the machine readable instructions. Additionally or alternatively, the communication circuitry 202 may be instantiated by any other combination of hardware, software, and/or firmware. For example, the communication circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the machine learning platform 102 includes means for preprocessing. For example, the means for preprocessing may be implemented by the preprocessing circuitry 204. In some examples, the preprocessing circuitry 204 may be instantiated by processor circuitry such as the example processor circuitry 1212 of FIG. 12. For instance, the preprocessing circuitry 204 may be instantiated by the example microprocessor 1300 of FIG. 13 executing machine executable instructions such as those implemented by at least blocks 902, 906, 908, 910, and 924 of FIG. 9. In some examples, the preprocessing circuitry 204 may be instantiated by hardware logic circuitry, which may be implemented by an ASIC, XPU, or the FPGA circuitry 1400 of FIG. 14 structured to perform operations corresponding to the machine readable instructions. Additionally or alternatively, the preprocessing circuitry 204 may be instantiated by any other combination of hardware, software, and/or firmware. For example, the preprocessing circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

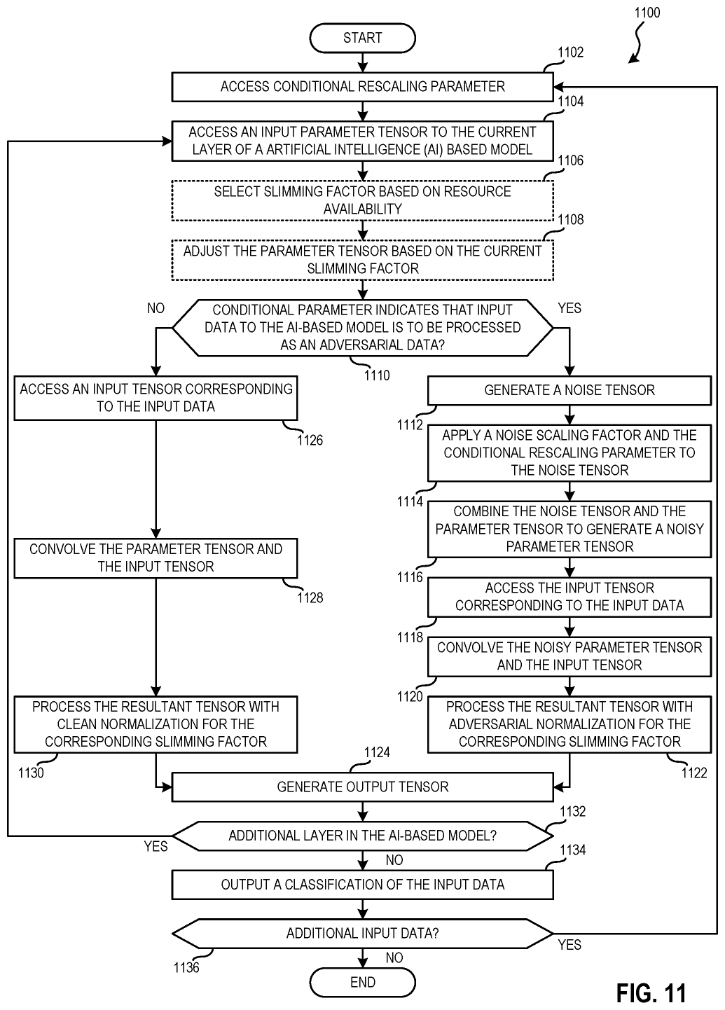

In some examples, the machine learning platform 102 includes means for executing. For example, the means for executing may be implemented by the model execution circuitry 206. In some examples, the model execution circuitry 206 may be instantiated by processor circuitry such as the example processor circuitry 1212 of FIG. 12. For instance, the model execution circuitry 206 may be instantiated by the example microprocessor 1300 of FIG. 13 executing machine executable instructions such as those implemented by at least block 912 of FIG. 9, at least blocks 1002, 1004, 1006, 1008, 1010, 1012, 1014, 1016, 1018, 1020, 1022, 1024, 1026, 1028, 1030, 1032, and 1034 of FIG. 10, and/or at least blocks 1102, 1104, 1106, 1108, 1110, 1112, 1114, 1116, 1118, 1120, 1122, 1124, 1126, 1128, 1130, 1132, 1134, and 1136 of FIG. 11. In some examples, the model execution circuitry 206 may be instantiated by hardware logic circuitry, which may be implemented by an ASIC, XPU, or the FPGA circuitry 1400 of FIG. 14 structured to perform operations corresponding to the machine readable instructions. Additionally or alternatively, the model execution circuitry 206 may be instantiated by any other combination of hardware, software, and/or firmware. For example, the model execution circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the machine learning platform 102 includes means for adjusting. For example, the means for adjusting may be implemented by the parameter adjustment circuitry 208. In some examples, the parameter adjustment circuitry 208 may be instantiated by processor circuitry such as the example processor circuitry 1212 of FIG. 12. For instance, the parameter adjustment circuitry 208 may be instantiated by the example microprocessor 1300 of FIG. 13 executing machine executable instructions such as those implemented by at least blocks 914, 916, 920, 922, 934, and 936 of FIG. 9. In some examples, the parameter adjustment circuitry 208 may be instantiated by hardware logic circuitry, which may be implemented by an ASIC, XPU, or the FPGA circuitry 1400 of FIG. 14 structured to perform operations corresponding to the machine readable instructions. Additionally or alternatively, the parameter adjustment circuitry 208 may be instantiated by any other combination of hardware, software, and/or firmware. For example, the parameter adjustment circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the machine learning platform 102 includes means for compressing. For example, the means for compressing may be implemented by the compression control circuitry 210. In some examples, the compression control circuitry 210 may be instantiated by processor circuitry such as the example processor circuitry 1212 of FIG. 12. For instance, the compression control circuitry 210 may be instantiated by the example microprocessor 1300 of FIG. 13 executing machine executable instructions such as those implemented by at least blocks 918, 926, 928, 930, and 932 of FIG. 9. In some examples, the compression control circuitry 210 may be instantiated by hardware logic circuitry, which may be implemented by an ASIC, XPU, or the FPGA circuitry 1400 of FIG. 14 structured to perform operations corresponding to the machine readable instructions. Additionally or alternatively, the compression control circuitry 210 may be instantiated by any other combination of hardware, software, and/or firmware. For example, the compression control circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model execution circuitry 206 includes means for evaluating. For example, the means for evaluating may be implemented by the adversarial evaluation circuitry 302. In some examples, the adversarial evaluation circuitry 302 may be instantiated by processor circuitry such as the example processor circuitry 1212 of FIG. 12. For instance, the adversarial evaluation circuitry 302 may be instantiated by the example microprocessor 1300 of FIG. 13 executing machine executable instructions such as those implemented by at least blocks 1002, 1008, and 1034 of FIG. 10 and/or at least blocks 1102, 1110, and 1136 of FIG. 11. In some examples, the adversarial evaluation circuitry 302 may be instantiated by hardware logic circuitry, which may be implemented by an ASIC, XPU, or the FPGA circuitry 1400 of FIG. 14 structured to perform operations corresponding to the machine readable instructions. Additionally or alternatively, the adversarial evaluation circuitry 302 may be instantiated by any other combination of hardware, software, and/or firmware. For example, the adversarial evaluation circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model execution circuitry 206 includes means for controlling a parameter tensor. For example, the means for controlling a parameter tensor may be implemented by the parameter tensor control circuitry 304. In some examples, the parameter tensor control circuitry 304 may be instantiated by processor circuitry such as the example processor circuitry 1212 of FIG. 12. For instance, the parameter tensor control circuitry 304 may be instantiated by the example microprocessor 1300 of FIG. 13 executing machine executable instructions such as those implemented by at least blocks 1004 and 1006 of FIG. 10 and/or at least blocks 1104, 1106, and 1108 of FIG. 11. In some examples, the parameter tensor control circuitry 304 may be instantiated by hardware logic circuitry, which may be implemented by an ASIC, XPU, or the FPGA circuitry 1400 of FIG. 14 structured to perform operations corresponding to the machine readable instructions. Additionally or alternatively, the parameter tensor control circuitry 304 may be instantiated by any other combination of hardware, software, and/or firmware. For example, the parameter tensor control circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model execution circuitry 206 includes means for generating a noisy parameter tensor. For example, the means for generating a noisy parameter tensor may be implemented by the noisy parameter tensor generation circuitry 306. In some examples, the noisy parameter tensor generation circuitry 306 may be instantiated by processor circuitry such as the example processor circuitry 1212 of FIG. 12. For instance, the noisy parameter tensor generation circuitry 306 may be instantiated by the example microprocessor 1300 of FIG. 13 executing machine executable instructions such as those implemented by at least blocks 1010, 1012, and 1014 of FIG. 10 and/or at least blocks 1112, 1114, and 1116 of FIG. 11. In some examples, the noisy parameter tensor generation circuitry 306 may be instantiated by hardware logic circuitry, which may be implemented by an ASIC, XPU, or the FPGA circuitry 1400 of FIG. 14 structured to perform operations corresponding to the machine readable instructions. Additionally or alternatively, the noisy parameter tensor generation circuitry 306 may be instantiated by any other combination of hardware, software, and/or firmware. For example, the noisy parameter tensor generation circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model execution circuitry 206 includes means for convolving. For example, the means for convolving may be implemented by the convolution circuitry 308. In some examples, the convolution circuitry 308 may be instantiated by processor circuitry such as the example processor circuitry 1212 of FIG. 12. For instance, the convolution circuitry 308 may be instantiated by the example microprocessor 1300 of FIG. 13 executing machine executable instructions such as those implemented by at least blocks 1016, 1018, 1024, and 1026 of FIG. 10 and/or at least blocks 1118, 1120, 1126, and 1128 of FIG. 11. In some examples, the convolution circuitry 308 may be instantiated by hardware logic circuitry, which may be implemented by an ASIC, XPU, or the FPGA circuitry 1400 of FIG. 14 structured to perform operations corresponding to the machine readable instructions. Additionally or alternatively, the convolution circuitry 308 may be instantiated by any other combination of hardware, software, and/or firmware. For example, the convolution circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model execution circuitry 206 includes means for normalizing. For example, the means for normalizing may be implemented by the normalization circuitry 310. In some examples, the normalization circuitry 310 may be instantiated by processor circuitry such as the example processor circuitry 1212 of FIG. 12. For instance, the normalization circuitry 310 may be instantiated by the example microprocessor 1300 of FIG. 13 executing machine executable instructions such as those implemented by at least blocks 1020 and 1028 of FIG. 10 and/or at least blocks 1122 and 1130 of FIG. 11. In some examples, the normalization circuitry 310 may be instantiated by hardware logic circuitry, which may be implemented by an ASIC, XPU, or the FPGA circuitry 1400 of FIG. 14 structured to perform operations corresponding to the machine readable instructions. Additionally or alternatively, the normalization circuitry 310 may be instantiated by any other combination of hardware, software, and/or firmware. For example, the normalization circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model execution circuitry 206 includes means for generating an output. For example, the means for generating an output may be implemented by the output control circuitry 312. In some examples, the output control circuitry 312 may be instantiated by processor circuitry such as the example processor circuitry 1212 of FIG. 12. For instance, the output control circuitry 312 may be instantiated by the example microprocessor 1300 of FIG. 13 executing machine executable instructions such as those implemented by at least blocks 1022, 1030, and 1032 of FIG. 10 and/or at least blocks 1124, 1132, and 1134 of FIG. 11. In some examples, the output control circuitry 312 may be instantiated by hardware logic circuitry, which may be implemented by an ASIC, XPU, or the FPGA circuitry 1400 of FIG. 14 structured to perform operations corresponding to the machine readable instructions. Additionally or alternatively, the output control circuitry 312 may be instantiated by any other combination of hardware, software, and/or firmware. For example, the output control circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

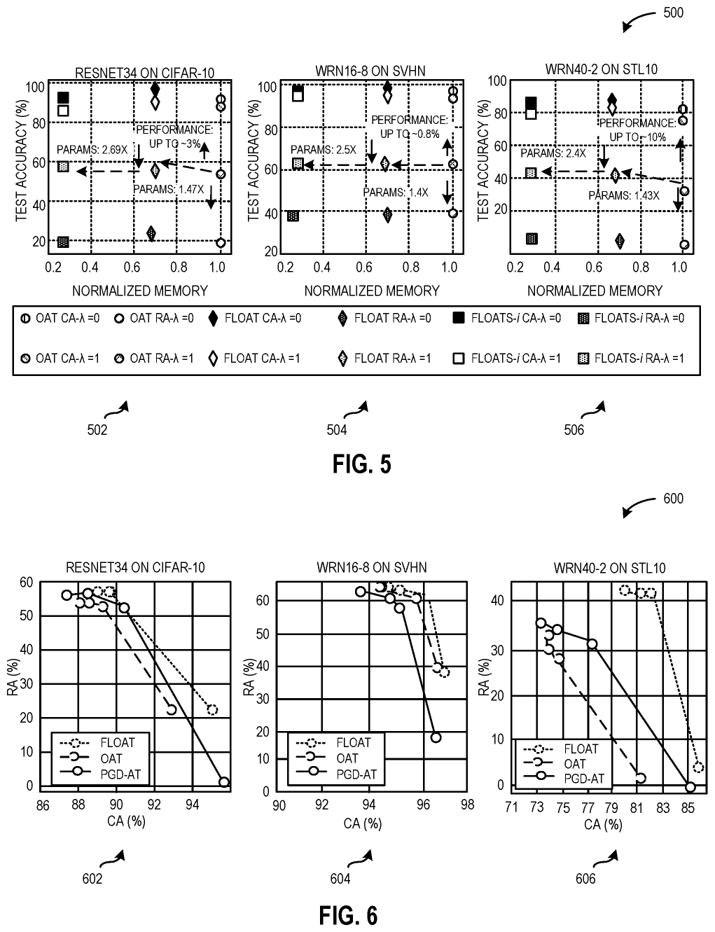

FIG. 4 is a block diagram illustrating an example layer 400 of example neural networks disclosed herein. In the example of FIG. 4, the parameter tensor control circuitry 304 accesses, obtains, and/or receives an example weight tensor 402 (θ^{l}) to the layer 400. If the machine learning platform 102 is implementing FLOAT slim, the parameter tensor control circuitry 304 adjusts the parameter tensor based on the selected slimming factor (SF) (e.g., w₁, w₂, w₃, etc.) reduces the number of active channels of the weight tensor θ^{l} for the current layer of the CNN by applying a bitmask tensor to the channels of the weight tensor θ^{l}. Based on a conditional parameter, the adversarial evaluation circuitry 302 determines whether input data to the CNN is to be processed as clean data or adversarial data. For example, during training, the adversarial evaluation circuitry 302 determines whether the conditional parameter (λ) is zero or one. During inference, the adversarial evaluation circuitry 302 determines whether the conditional rescaling parameter (λₙ) satisfies the condition threshold (λₜₕ).

In the illustrated example of FIG. 4, in response to the adversarial evaluation circuitry 302 determining that the input data (e.g., an input image) to the CNN is to be processed as adversarial data, the noisy parameter tensor generation circuitry 306 generates an example noise tensor 404 (η^{l}) and applies the noise scaling factor α^{l} to the noise tensor 404 (η^{l}) (e.g., via element-wise multiplication). If the machine learning platform 102 is implementing FLOAT slim, the noisy parameter tensor generation circuitry 306 generates the example noise tensor 404 (η^{l}) based on the selected SF (e.g., w₁, w₂, w₃, etc.). During inference, the noisy parameter tensor generation circuitry 306 also applies the conditional rescaling parameter (λₙ) to the noise tensor 404 (η^{l}). The noisy parameter tensor generation circuitry 306 generates an example noisy weight tensor 406 (\hat{θ}^{l}) by combining (operation 408) the weight tensor 402 (θ^{l}) with the noise tensor 404 (η^{l}). For example, to combine (operation 408) the weight tensor 402 (θ^{l}) and the noise tensor 404 (η^{l}), the noisy parameter tensor generation circuitry 306 performs element-wise addition. Accordingly, the noisy parameter tensor generation circuitry 306 supports multiple SFs.

In the illustrated example of FIG. 4, in response to the adversarial evaluation circuitry 302 determining that the input image to the CNN is to be processed as an adversarial image, the convolution circuitry 308 convolves (operation 410) the noisy weight tensor 406 (\hat{θ}^{l}) and an example input feature map (IFM) 412 to the layer 400 (e.g., IFM_{A} for adversarial image processing). In response to the adversarial evaluation circuitry 302 determining that the input image to the CNN is to be processed as an adversarial image, the normalization circuitry 310 executes an example adversarial batch-normalization sub-layer 414 (e.g., BN_{A}) to generate an example resultant adversarial tensor 416. If the machine learning platform 102 is implementing FLOAT slim, the normalization circuitry 310 executes the adversarial batch-normalization sub-layer 414 for the corresponding SF (e.g., w₁, w₂, w₃, etc.). The output control circuitry 312 generates an output tensor for the layer 400 based on the resultant adversarial tensor 416. For example, the output control circuitry 312 applies the ReLU activation function to the resultant adversarial tensor 416.

In the illustrated example of FIG. 4, in response to the adversarial evaluation circuitry 302 determining that the input image to the CNN is to be processed as a clean image, the convolution circuitry 308 convolves (operation 420) the weight tensor 402 (θ^{l}) and an example IFM 422 to the layer 400 (e.g., IFM_{C} for clean image processing). In response to the adversarial evaluation circuitry 302 determining that the input image to the CNN is to be processed as a clean image, the normalization circuitry 310 executes an example clean batch-normalization sub-layer 424 (e.g., BN_{C}) to generate an example resultant clean tensor 426. If the machine learning platform 102 is implementing FLOAT slim, the normalization circuitry 310 executes the clean batch-normalization sub-layer 424 for the corresponding SF (e.g., w₁, w₂, w₃, etc.). The output control circuitry 312 generates an output tensor for the layer 400 based on the resultant clean tensor 426. For example, the output control circuitry 312 applies the ReLU activation function to the resultant clean tensor 426.

In examples disclosed herein, because mean and variance of the post-convolution feature maps for clean and adversarial processing can differ significantly, the example normalization circuitry 310 includes at least two batch-normalization sub-layers. For example, implementing only one batch-normalization sub-layer for both distributions of data (e.g., adversarial images and clean images) can limit the performance of the model. Therefore, examples disclosed herein improve model performance. In the example of FIG. 4, at least one batch-normalization sub-layer (e.g., BN_{C}) of the normalization circuitry 310 is dedicated for processing the IFM 422 (e.g., IFM_{C} for clean image processing) and at least one batch-normalization sub-layer (e.g., BN_{A}) of the normalization circuitry 310 is dedicated for processing the IFM 412 (e.g., IFM_{A} for adversarial image processing).

As described above, the machine learning platform 102 implements FLOAT, FLOATS-i, FLOATS-c, and/or FLOAT slim to train ML models. For example, the machine learning platform 102 can implement any combination of FLOAT, FLOATS-i, FLOATS-c, and FLOAT slim. For example, a developer in charge of training models using the machine learning platform 102 may elect to implement irregular pruning (e.g., FLOATS-i) when training models that are to be deployed in resource constrained environments. Additionally or alternatively, to further ensure that the models pruned with irregular pruning (e.g., FLOATS-i) have structure to enable reduced runtime (e.g., to speed-up performance) on a wide range of existing hardware, a developer in charge of training models using the machine learning platform 102 may elect to implement structured pruning (e.g., FLOATS-c) to perform model parameter reduction at the level of channels.

Additionally or alternatively, to simultaneously benefit from aggressive parameter reduction via irregular pruning (e.g., FLOATS-i) and width reduction via channel pruning (e.g., FLOAT-c) while maintaining high accuracy, a developer in charge of training models using the machine learning platform 102 may elect to implement FLOATS slim (e.g., a combination of FLOATS-i, FLOATS-c, and FLOAT slim). For example, in addition to the different numbers of parameters per layer of the model (e.g., a locally irregular model) yielded by FLOATS-i, implementing FLOATS-i with FLOAT slim yields a model with even fewer parameters for a specific slimming factor (SF). To train using FLOATS and FLOAT slim, the machine learning platform 102 simultaneously performs the optimizations of FLOATS and FLOAT slim, training with multiple SFs, including an SF equal to one.

Example pseudocode representative of instructions executed by the machine learning platform 102 to implement FLOATS is shown below in Pseudocode 1.

| | |
|---|---|
| Pseudocode 1 | FLOATS Algorithm |
| Data: | Training set X having distribution D having labels |
| | Y, model parameters Θ, trainable noises scaling |
| | factors α, binary conditioning parameter λ, batch- |
| | size B, global parameter density d, bitmask Π, |
| | and prune type (irregular/channel) tₚ |
| Output: | Trained model parameters Θ with density d and |
| | trained noise scaling factors α |
| 1. | Θ ←applyMask(Θ, Π) |
| 2. | for i ← 0 to ep do |
| 3. | for j ← 0 to n_{B} do |
| 4. | B/2 (X_{0:B/2}, Y_{0:B/2}) ~ D |
| 5. | [symbol] _{c} ← computeLoss(X_{0:B/2}, Θ, λ = 0, α, Y_{0:B/2}) |
| 6. | \hat{X}:_{B/2:B} ← createAdv(X_{B/2:B}, Y_{B/2:B}) |
| 7. | [symbol] _{A} ← computeLoss(\hat{X}:_{B/2:B}, Θ, λ = 1, α, Y_{B/2:B}) |
| 8. | [symbol] _{Total} ← 0.5* [symbol] _{C} + 0.5* [symbol] _{A} |
| 9. | updateParam(Θ, α, ∇_{L}, Π) |
| 10. | end |
| 11. | UpdateLayerMetric(μ) |
| 12. | pruneRegrow(Θ, Π, μ, d) |
| 13. | Π ← updateMask(Π, tₚ, μ) |
| 14. | end |
| | Pseudocode 1 |

At line 1 of Pseudocode 1, the preprocessing circuitry 204 applies a bitmask Π to the parameters Θ of the model. For example, the preprocessing circuitry 204 applies a bitmask tensor π^{l} to the parameter tensor θ^{l} for each layer l of the model. For each epoch of training, the preprocessing circuitry 204 divides (e.g., separates, groups, etc.) the training dataset X into n_{B} batches of size B (line 2). For each batch of the training dataset, the preprocessing circuitry 204 divides the batch in half into a first training dataset and a second training dataset (e.g., X_{0:B/2} and X_{B/2:B}) (lines 3 and 4).

At line 5 of Pseudocode 1, the model execution circuitry 206 executes the model on the clean training dataset (e.g., X_{0:B/2}) and the parameter adjustment circuitry 208 computes the clean loss function according to Equation 2 above. At line 6 of Pseudocode 1, the preprocessing circuitry 204 perturbs the second training dataset (e.g., X_{B/2:B}) to generate an adversarial training dataset (e.g., \hat{X}_{B/2:B}). At line 7 of Pseudocode 1, the model execution circuitry 206 executes the model on the adversarial training dataset (e.g., X_{B/2:B}) and the parameter adjustment circuitry 208 computes the adversarial loss function according to Equation 3 above.

At line 8 of Pseudocode 1, the parameter adjustment circuitry 208 computes the total loss function according to Equation 4 above. In the example of Pseudocode 1, the coefficients A and B are both 0.5. In additional or alternative examples, the coefficients A and B may be different values. At like 9 of Pseudocode 1, the parameter adjustment circuitry 208 computes gradients ( [symbol] ) for the parameters Θ of the model and adjusts the parameters Θ and the noise scaling factors α based on the gradients and the bitmask Π.

At line 11 of Pseudocode 1, the compression control circuitry 210 computes metrics for each layer of the model and ranks the layers according based on the metrics. For example, when implementing FLOATS-i, the compression control circuitry 210 computes the momentum for each layer of the model. Additionally or alternatively, when implementing FLOATS-c, the compression control circuitry 210 computes the F-norm for each layer of the model. At line 12 of Pseudocode 1, the compression control circuitry 210 determines which layers of the model to adjust the weights of and the adjustments to be made to those layers based on the ranking of the layers and the global parameter constraint. At line 12, the compression control circuitry 210 updates the bitmask Π for the identified layers by making the adjustments for those layers.

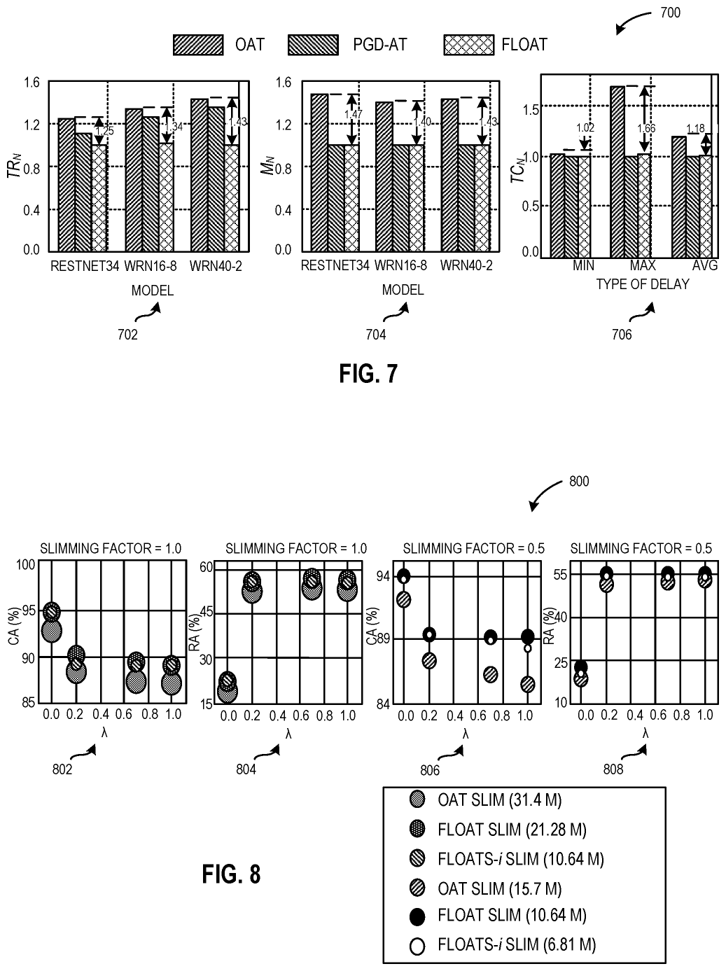

FIG. 5 is graphical illustration 500 comparing example performance metrics of (1) neural networks trained according to examples disclosed herein and (2) neural network trained according to other example techniques. In the example of FIG. 5, the graphical illustration 500 includes an example first plot 502, an example second plot 504, and an example third plot 506. In the example of FIG. 5, the first plot 502, the second plot 504, and the third plot 506 illustrate the clean accuracy (CA) and robust accuracy (RA) of various versions of different neural network architectures when classifying images from different training datasets. The various versions of a neural network architecture include versions trained according to the OAT approach, the FLOAT approach disclosed herein, and the FLOATS-i approach disclosed herein. Across the different architectures and datasets, models trained with the FLOAT and FLOATS approaches require significantly less memory while producing high accuracy when compared to models trained with the OAT approach.

In the illustrated example of FIG. 5, the first plot 502 illustrates the CA and RA for versions of the ResNet-34 model trained to classify images from the CIFAR-10 dataset according to the OAT approach, the FLOAT approach disclosed herein, and the FLOATS-i approach disclosed herein. As illustrated in the first plot 502, the versions of the ResNet-34 model that were trained with the FLOAT and FLOATS-i approaches achieve ˜3% improved RA as compared to the OAT trained version of the ResNet-34 model. Additionally, the version of the ResNet-34 model that was trained with the FLOAT approach requires ˜1.47× less parameters than the OAT trained version of the ResNet-34 model. Similarly, the version of the ResNet-34 model that was trained with the FLOATS-i approach requires ˜2.69× less parameters than the OAT trained version of the ResNet-34 model.

In the illustrated example of FIG. 5, the second plot 504 illustrates the CA and RA for versions of the WRN16-8 model trained to classify images from the SVHN dataset according to the OAT approach, the FLOAT approach disclosed herein, and the FLOATS-i approach disclosed herein. As illustrated in the second plot 504, the versions of the WRN16-8 model that were trained with the FLOAT and FLOATS-i approaches achieve ˜0.8% improved RA as compared to the OAT trained version of the WRN16-8 model. Additionally, the version of the WRN16-8 model that was trained with the FLOAT approach requires ˜1.4× less parameters than the OAT trained version of the WRN16-8 model. Similarly, the version of the WRN16-8 model that was trained with the FLOATS-i approach requires ˜2.5× less parameters than the OAT trained version of the WRN16-8 model.

In the illustrated example of FIG. 5, the third plot 506 illustrates the CA and RA for versions of the WRN40-2 model trained to classify images from the STL10 dataset according to the OAT approach, the FLOAT approach disclosed herein, and the FLOATS-i approach disclosed herein. As illustrated in the third plot 506, the versions of the WRN40-2 model that were trained with the FLOAT and FLOATS-i approaches achieve ˜10% improved RA as compared to the OAT trained version of the WRN40-2 model. Additionally, the version of the WRN40-2 model that was trained with the FLOAT approach requires ˜1.43× less parameters than the OAT trained version of the WRN40-2 model. Similarly, the version of the WRN40-2 model that was trained with the FLOATS-i approach requires ˜2.4× less parameters than the OAT trained version of the WRN40-2 model.

FIG. 6 is graphical illustration 600 comparing example performance metrics of (1) neural networks trained according to examples disclosed herein and (2) neural network trained according to other techniques. In the example of FIG. 6, the graphical illustration 600 includes an example first plot 602, an example second plot 604, and an example third plot 606. In the example of FIG. 6, the first plot 602, the second plot 604, and the third plot 606 illustrate the CA-RA trade-off curves of various versions of different neural network architectures when classifying images from different training datasets. The various versions of a neural network architecture include versions trained according to the OAT approach, the FLOAT approach disclosed herein, and the PGD adversarial training (PGD-AT) approach. Across different robustness settings, models trained according to the FLOAT approach outperform models trained according to the OAT and PGD-AT approaches.

FIG. 7 is graphical illustration 700 comparing example performance metrics of (1) neural networks trained according to examples disclosed herein and (2) neural network trained according to other techniques. In the example of FIG. 7, the graphical illustration 700 includes an example first plot 702, an example second plot 704, and an example third plot 706. In the example of FIG. 7, the first plot 702, the second plot 704, and the third plot 706 illustrate the normalized training time per epoch, the model parameter storage requirements, and the computational delay of convolution operations executed on ASICs, respectively, of various versions of different neural network architectures when classifying images from the CIFAR-10 dataset. The various versions of a neural network architecture include versions trained according to the OAT approach, the FLOAT approach disclosed herein, and the PGD-AT approach.

FIG. 8 is graphical illustration 800 comparing example performance metrics of (1) neural networks trained according to examples disclosed herein and (2) neural network trained according to other techniques. In the example of FIG. 8, the graphical illustration 800 includes an example first plot 802, an example second plot 804, an example third plot 806, and an example fourth plot 808. In the example of FIG. 8, the first plot 802, the second plot 804, the third plot 806, and the fourth plot 808 compare the CA of various versions of the ResNet-34 when classifying images from the CIFAR-10 dataset. The various versions of the ResNet-34 model include versions trained according to the OAT slim approach, the FLOAT slim approach disclosed herein, and the FLOATS-i slim approach disclosed herein. In the example of FIG. 8, a smaller circle indicates a smaller model in terms of parameters.

While an example manner of implementing the machine learning platform 102 of FIG. 1 is illustrated in FIG. 2, one or more of the elements, processes, and/or devices illustrated in FIG. 2 may be combined, divided, re-arranged, omitted, eliminated, and/or implemented in any other way. Additionally, while an example manner of implementing the model execution circuitry 206 of FIG. 2 is illustrated in FIG. 3, one or more of the elements, processes, and/or devices illustrated in FIG. 3 may be combined, divided, re-arranged, omitted, eliminated, and/or implemented in any other way. Further, the example communication circuitry 202, the example preprocessing circuitry 204, the example parameter adjustment circuitry 208, the example compression control circuitry 210, the example datastore 212, and/or, more generally, the example machine learning platform of FIGS. 1 and/or 2, and/or the example adversarial evaluation circuitry 302, the example parameter tensor control circuitry 304, the example noisy parameter tensor generation circuitry 306, the example convolution circuitry 308, the example normalization circuitry 310, the example output control circuitry, and/or, more generally, the example model execution circuitry 206 of FIGS. 2 and/or 3, may be implemented by hardware alone or by hardware in combination with software and/or firmware. Thus, for example, any of the example communication circuitry 202, the example preprocessing circuitry 204, the example parameter adjustment circuitry 208, the example compression control circuitry 210, the example datastore 212, and/or, more generally, the example machine learning platform of FIGS. 1 and/or 2, and/or the example adversarial evaluation circuitry 302, the example parameter tensor control circuitry 304, the example noisy parameter tensor generation circuitry 306, the example convolution circuitry 308, the example normalization circuitry 310, the example output control circuitry, and/or, more generally, the example model execution circuitry 206 of FIGS. 2 and/or 3, could be implemented by processor circuitry, analog circuit(s), digital circuit(s), logic circuit(s), programmable processor(s), programmable microcontroller(s), graphics processor unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example machine learning platform 102 of FIGS. 1 and/or 2 and/or the example model execution circuitry 206 of FIGS. 2 and/or 3 may include one or more elements, processes, and/or devices in addition to, or instead of, those illustrated in FIGS. 2 and/or 3, and/or may include more than one of any or all of the illustrated elements, processes and devices.

A flowchart representative of example machine readable instructions, which may be executed to configure processor circuitry to implement the machine learning platform 102 of FIGS. 1 and/or 2, is shown in FIG. 9. Flowcharts representative of example machine readable instructions, which may be executed to configure processor circuitry to implement the model execution circuitry 206 of FIGS. 2 and/or 3, are shown in FIGS. 10 and/or 11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 9, 10, and/or 11, many other methods of implementing the example machine learning platform 102 and/or the model execution circuitry 206 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9, 10, and/or 11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed and/or instantiated by example processor circuitry to implement the machine learning platform 102 of FIGS. 1 and/or 2 to train a machine learning model to perform classification on datasets that may have different distributions. The machine readable instructions and/or the operations 900 of FIG. 9 begin at block 902, at which the preprocessing circuitry 204 applies a bitmask to the parameters of an artificial intelligence (AI) based model. For example, the preprocessing circuitry 204 applies a bitmask Π to the parameters Θ of a CNN model to reduce the overall number of non-zero values of the parameters Θ. During training, the zero values of the bitmask Π are adjusted to improve the performance of the model when the parameters Θ of the model are masked by the bitmask Π.

In the illustrated example of FIG. 9, at block 904, the communication circuitry 202 accesses, obtains, and/or receives a training dataset for the AI-based model. For example, the communication circuitry 202 accesses a publicly available image training dataset over the network 106 of FIG. 1. At block 906, the preprocessing circuitry 204 partitions (e.g., divides, batches, groups, etc.) the training dataset into one or more batches. At block 908, for the current batch of the training dataset, the preprocessing circuitry 204 partitions the batch into a first training dataset and a second training dataset where the first training dataset is a clean training dataset. For example, at block 908, the preprocessing circuitry 204 can split the current batch of the training dataset in half by randomly (e.g., pseudo-randomly) sampling the current batch of the training dataset.

In the illustrated example of FIG. 9, at block 910, the preprocessing circuitry 204 perturbs (e.g., adjusts, alters, etc.) the second training dataset with an adversarial attack to generate an adversarial training dataset. For example, at block 910, the preprocessing circuitry 204 perturbs the second training dataset with the PGD-7 adversarial attack. At block 912, the model execution circuitry 206 processes the clean training dataset and the adversarial training dataset with the AI-based model. At block 912, the model execution circuitry 206 optionally processes the clean and adversarial training datasets according to a slimming factor to reduce the width of the layers of the model on a global basis. An example implementation of block 912 is illustrated and described in connection with FIG. 10.

In the illustrated example of FIG. 9, at block 914, the parameter adjustment circuitry 208 computes a loss function for the AI-based model. For example, the parameter adjustment circuitry 208 computes the loss function for the AI-based model according to the above Equations 2, 3, and 4. At block 916, the parameter adjustment circuitry 208 determines gradients for the parameters of the AI-based model. For example, the parameter adjustment circuitry 208 executes the backpropagation algorithm to determine the gradients for the parameters of the AI-based model. At block 918, the compression control circuitry 210 determines whether there is an additional slimming factor with which to process the clean and adversarial training datasets. In response to the compression control circuitry 210 determining that is an additional slimming factor (block 918: YES), the machine readable instructions and/or the operations 900 return to block 912. In response to the compression control circuitry 210 determining that there is not an additional slimming factor (block 918: NO), the machine readable instructions and/or the operations 900 proceed to block 914.

In the illustrated example of FIG. 9, at block 920, the parameter adjustment circuitry 208 adjusts the parameters of the AI-based model and noise scaling factors of the AI-based model based on the gradients. For example, the parameter adjustment circuitry 208 adjusts the parameters of the AI-based model and noise scaling factors of the AI-based model via stochastic gradient decent. At block 922, the parameter adjustment circuitry 208 adjusts the parameters of the AI-based model and noise scaling factors of the AI-based model based on the gradients and the bitmask (e.g., the bitmask Π). At block 924, the preprocessing circuitry 204 determines whether there is an additional batch of the training dataset with which to train the AI-based model.

In the illustrated example of FIG. 9, in response to the preprocessing circuitry 204 determining that there is an additional batch of the training dataset (block 924: YES), the machine readable instructions and/or the operations 900 return to block 908. In response to the preprocessing circuitry 204 determining that there is not an additional batch of the training dataset (block 924: NO), the machine readable instructions and/or the operations 900 proceed to block 926. At block 926, the compression control circuitry 210 computes one or more metrics for each layer of the AI-based model. For example, when implementing the FLOATS-i approach, the compression control circuitry 210 computes the normalized momentum for each layer of the AI-based model. Additionally, for example, when implementing the FLOATS-c approach, the compression control circuitry 210 computes the F-norm for each layer of the AI-based model.

In the illustrated example of FIG. 9, at block 928, the compression control circuitry 210 determines a ranking of the layers of the AI-based model based on the one or more metrics. At block 930, the compression control circuitry 210 determines the layers of the AI-based model for which to adjust the bitmask (e.g., the bitmask Π) and the adjustments to be made to the layers. At block 932, the compression control circuitry 210 updates the bitmask (e.g., the bitmask Π) based on the adjustments.

In the illustrated example of FIG. 9, at block 934 the parameter adjustment circuitry 208 determines whether there is an additional epoch for which to train the AI-based model. In the illustrated example of FIG. 9, in response to the parameter adjustment circuitry 208 determining that there is an additional epoch for which to train the AI-based model (block 934: YES), the machine readable instructions and/or the operations 900 return to block 902. In response to the parameter adjustment circuitry 208 determining that there is not an additional epoch for which to train the AI-based model (block 934: NO), the machine readable instructions and/or the operations 900 proceed to block 936.

In the illustrated example of FIG. 9, at block 936, the parameter adjustment circuitry 208 outputs, saves, stores, transmits, sends, and/or deploys the trained AI-based model. For example, the parameter adjustment circuitry 208 saves the parameters Θ in the datastore 212. Subsequently, the communication circuitry 202 may transmit the parameters Θ to another device (e.g., the endpoint device 104) to facilitate execution of the trained AI-based model at the other device. Additionally or alternatively, the model execution circuitry 206 may access the parameters Θ from the datastore 212 to execute the trained AI-based model.

In the illustrated example of FIG. 9, blocks 902, 918, 922, 926, 928, 930, and/or 932 may be included in or omitted from the machine readable instructions and/or the operations 900 based on the training approach (e.g., FLOAT, FLOATS, FLOAT slim, FLOATS slim, etc.) implemented by a developer of the AI-based model. For example, blocks 902, 922, 926, 928, 930, and 932 may be included in the machine readable instructions and/or the operations 900 when a developer of an AI-based model wishes to implement FLOATS (e.g., FLOATS-i and/or FLOATS-c). Additionally or alternatively, block 918 may be included in the machine readable instructions and/or the operations 900 when a developer of an AI-based model wishes to implement FLOAT slim and/or FLOATS slim.

FIG. 10 is a flowchart representative of example machine readable instructions and/or example operations 912 that may be executed and/or instantiated by example processor circuitry to implement the model execution circuitry 206 of FIGS. 2 and/or 3 to classify, during a training phase, data from datasets that may have different distributions. The machine readable instructions and/or the operations 912 of FIG. 10 begin at block 1002, at which the adversarial evaluation circuitry 302 accesses, obtains, and/or receives a conditional parameter (λ) for input data to the AI-based model from the datastore 212.

In the illustrated example of FIG. 10, at block 1004, the parameter tensor control circuitry 304 accesses a parameter tensor (e.g., θ¹) for the current layer of the AI-based model from the datastore 212. At block 1006, the parameter tensor control circuitry 304 adjusts the parameter tensor based on the current slimming factor. For example, at block 1006, the parameter tensor control circuitry 304 applies a bitmask tensor to the channels of the parameter tensor (e.g., θ^{l}). At block 1008, the adversarial evaluation circuitry 302 determines whether the conditional parameter indicates that the input data is to be processed as adversarial data. For example, at block 1008, the adversarial evaluation circuitry 302 determines whether the conditional parameter (λ) is zero or one.

In the illustrated example of FIG. 10, in response to the adversarial evaluation circuitry 302 determining that the conditional parameter indicates that the input data is to be processed as adversarial data (block 1008: YES), the machine readable instructions and/or the operations 912 proceed to block 1010. At block 1010, the noisy parameter tensor generation circuitry 306 generates a noise tensor. For example, the noisy parameter tensor generation circuitry 306 generates the noise tensor η^{l} according to a normal distribution with a mean of zero and a standard deviation of σ^{l}. At block 1012, the noisy parameter tensor generation circuitry 306 applies a noise scaling factor α^{l} for the current layer/of the AI-based model to the noise tensor η^{l}. For example, the noisy parameter tensor generation circuitry 306 multiplies the noise tensor η^{l} by the noise scaling factor α^{l}.

In the illustrated example of FIG. 10, at block 1014, the noisy parameter tensor generation circuitry 306 combines the noise tensor and the parameter tensor to generate a noisy parameter tensor (e.g., \hat{θ}^{l}). For example, to combine the parameter tensor (e.g., θ^{l}) and the noise tensor (e.g., η^{l}), the noisy parameter tensor generation circuitry 306 performs element-wise addition using elements of the parameter tensor and elements of the noise tensor. At block 1016, the convolution circuitry 308 accesses an input tensor corresponding to the input data. For example, for the first layer of the AI-based model, the convolution circuitry 308 accesses an input feature map (IFM) tensor representative of an input image. Additionally, for example, for subsequent layers of the AI-based model, the convolution circuitry 308 accesses, obtains, and/or receives the tensor output from the previous layer of the AI-based model.

In the illustrated example of FIG. 10, at block 1018, the convolution circuitry 308 convolves the noisy parameter tensor (e.g., \hat{θ}^{l}) and the input tensor. At block 1020, the normalization circuitry 310 processes the resultant tensor output from the convolution circuitry 308 with adversarial normalization. Additionally, at block 1020, if the machine learning platform 102 is implementing FLOAT slim and/or FLOATS slim, the normalization circuitry 310 processes the resultant tensor output from the convolution circuitry 308 with adversarial normalization for the corresponding slimming factor. At block 1022, the output control circuitry 312 generates an output tensor for the current layer of the AI-based model.

Returning to block 1008, in response to the adversarial evaluation circuitry 302 determining that the conditional parameter indicates that the input data is to be processed as clean data (block 1008: NO), the machine readable instructions and/or the operations 912 proceed to block 1024. At block 1024, the convolution circuitry 308 accesses the input tensor corresponding to the input data. For example, for the first layer of the AI-based model, the convolution circuitry 308 accesses the IFM tensor representative of an input image. Additionally, for example, for subsequent layers of the AI-based model, the convolution circuitry 308 accesses the tensor output from the previous layer of the AI-based model.

In the illustrated example of FIG. 10, at block 1026, the convolution circuitry 308 convolves the parameter tensor (e.g., θ^{l}) and the input tensor. At block 1028, the normalization circuitry 310 processes the resultant tensor output from the convolution circuitry 308 with clean normalization. Additionally, at block 1028, if the machine learning platform 102 is implementing FLOAT slim and/or FLOATS slim, the normalization circuitry 310 processes the resultant tensor output from the convolution circuitry 308 with clean normalization for the corresponding slimming factor.

In the illustrated example of FIG. 10, at block 1030, the output control circuitry 312 determines whether there is an additional layer in the AI-based model. In response to the output control circuitry 312 determining that there is an additional layer in the AI-based model (block 1030: YES), the machine readable instructions and/or the operations 912 return to block 1004. In response to the output control circuitry 312 determining that there is not an additional layer in the AI-based model (block 1030: NO), the machine readable instructions and/or the operations 912 proceed to block 1032. At block 1032, the output control circuitry 312 outputs a classification of the input data.

In the illustrated example of FIG. 10, at block 1034, the adversarial evaluation circuitry 302 determines whether there is additional data in the clean training dataset or the adversarial training dataset. In response to the adversarial evaluation circuitry 302 determining that there is additional data in the clean training dataset or the adversarial training dataset (block 1034: YES), the machine readable instructions and/or the operations 912 return to block 1002. In response to the adversarial evaluation circuitry 302 determining that there is no additional data in the clean training dataset or the adversarial training dataset (block 1034: NO), the machine readable instructions and/or the operations 912 return to the machine readable instructions and/or the operations 900 at block 914.

In the illustrated example of FIG. 10, block 1006 may be included in or omitted from the machine readable instructions and/or the operations 912 based on the training approach (e.g., FLOAT, FLOATS, FLOAT slim, FLOATS slim, etc.) implemented by a developer of the AI-based model. For example, block 1006 may be included in the machine readable instructions and/or the operations 912 when a developer of an AI-based model wishes to implement FLOAT slim or FLOATS slim. Alternatively, if a developer wishes to implement FLOAT or FLOATS, block 1006 may be omitted from the machines readable instructions and/or the operations 912.

FIG. 11 is a flowchart representative of example machine readable instructions and/or example operations 1100 that may be executed and/or instantiated by example processor circuitry to implement the model execution circuitry 206 of FIGS. 2 and/or 3 to classify, during an inference phase, data from datasets that may have different distributions. The machine readable instructions and/or the operations 1100 of FIG. 11 begin at block 1102, at which the adversarial evaluation circuitry 302 accesses, obtains, and/or receives a conditional rescaling parameter (λₙ) for the AI-based model.

In the illustrated example of FIG. 11, at block 1104, the parameter tensor control circuitry 304 accesses, obtains, and/or receives a parameter tensor (e.g., θ^{l}) for the current layer of the AI-based model. At block 1106, the parameter tensor control circuitry 304 selects a slimming factor based on resource availability of the device executing the AI-based model. For example, if the available resources of a device are currently below a first threshold or are scheduled in such a manner that they will be below the first threshold in the future, the parameter tensor control circuitry 304 selects a first slimming factor. Additionally or alternatively, for a second threshold that is lower than the first threshold, if the available resources of a device are currently below the second threshold or are scheduled in such a manner that they will be below the second threshold in the future, the parameter tensor control circuitry 304 selects a second slimming factor, the second slimming factor greater than the first slimming factor.

In the illustrated example of FIG. 11, at block 1108, the parameter tensor control circuitry 304 adjusts the parameter tensor based on the current slimming factor. For example, at block 1108, the parameter tensor control circuitry 304 adjusts the parameter tensor by applying a bitmask tensor to the channels of the parameter tensor (e.g., θ^{l}). At block 1110, the adversarial evaluation circuitry 302 determines whether the conditional parameter indicates that the input data is to be processed as adversarial data. For example, at block 1110, the adversarial evaluation circuitry 302 determines whether the conditional rescaling parameter (λₙ) satisfies the condition threshold (λₜₕ) (e.g., λₙ>λₜₕ).

In the illustrated example of FIG. 11, in response to the adversarial evaluation circuitry 302 determining that the conditional parameter indicates that the input data is to be processed as adversarial data (block 1110: YES), the machine readable instructions and/or the operations 1100 proceed to block 1112. At block 1112, the noisy parameter tensor generation circuitry 306 generates a noise tensor. For example, the noisy parameter tensor generation circuitry 306 generates the noise tensor η^{l} according to a normal distribution with a mean of zero and a standard deviation of α^{l}. At block 1114, the noisy parameter tensor generation circuitry 306 applies a noise scaling factor α^{l} for the current layer l of the AI-based model and the conditional rescaling parameter (λₙ) to the noise tensor η^{l}. For example, the noisy parameter tensor generation circuitry 306 applies the noising scaling factor by multiplying the noise tensor η^{l} by the noise scaling factor α^{l} and the conditional rescaling parameter (λₙ).

In the illustrated example of FIG. 11, at block 1116, the noisy parameter tensor generation circuitry 306 combines the noise tensor and the parameter tensor to generate a noisy parameter tensor (e.g., [symbol] ). For example, to combine the parameter tensor (e.g., θ^{l}) and the noise tensor (e.g., η^{l}), the noisy parameter tensor generation circuitry 306 performs element-wise addition. At block 1118, the convolution circuitry 308 accesses, obtains, and/or receives an input tensor corresponding to the input data. For example, for the first layer of the AI-based model, the convolution circuitry 308 accesses an IFM tensor representative of an input image. Additionally, for example, for subsequent layers of the AI-based model, the convolution circuitry 308 accesses the tensor output from the previous layer of the AI-based model.

In the illustrated example of FIG. 11, at block 1120, the convolution circuitry 308 convolves the noisy parameter tensor (e.g., [symbol] ) and the input tensor. At block 1122, the normalization circuitry 310 processes the resultant tensor output from the convolution circuitry 308 with adversarial normalization. Additionally, at block 1122, if the machine learning platform 102 is implementing FLOAT slim and/or FLOATS slim, the normalization circuitry 310 processes the resultant tensor output from the convolution circuitry 308 with adversarial normalization for the corresponding slimming factor. At block 1124, the output control circuitry 312 generates an output tensor for the current layer of the AI-based model.

Returning to block 1110, in response to the adversarial evaluation circuitry 302 determining that the conditional parameter indicates that the input data is to be processed as clean data (block 1110: NO), the machine readable instructions and/or the operations 1100 proceed to block 1126. At block 1126, the convolution circuitry 308 accesses, obtains, and/or receives the input tensor corresponding to the input data. For example, for the first layer of the AI-based model, the convolution circuitry 308 accesses the IFM tensor representative of the input data. Additionally, for example, for subsequent layers of the AI-based model, the convolution circuitry 308 accesses the tensor output from the previous layer of the AI-based model.

In the illustrated example of FIG. 11, at block 1128, the convolution circuitry 308 convolves (e.g., determines a convolution of, computes a convolution of, generates the output of a convolution of, etc.) the parameter tensor (e.g., θ^{l}) and the input tensor. At block 1130, the normalization circuitry 310 processes the resultant tensor output from the convolution circuitry 308 with clean normalization. Additionally, at block 1132, if the machine learning platform 102 is implementing FLOAT slim and/or FLOATS slim, the normalization circuitry 310 processes the resultant tensor output from the convolution circuitry 308 with clean normalization for the corresponding slimming factor.

In the illustrated example of FIG. 11, at block 1132, the output control circuitry 312 determines whether there is an additional layer in the AI-based model. In response to the output control circuitry 312 determining that there is an additional layer in the AI-based model (block 1132: YES), the machine readable instructions and/or the operations 1100 return to block 1104. In response to the output control circuitry 312 determining that there is not an additional layer in the AI-based model (block 1132: NO), the machine readable instructions and/or the operations 1100 proceed to block 1134. At block 1134, the output control circuitry 312 outputs a classification of the input data.

In the illustrated example of FIG. 11, at block 1136, the adversarial evaluation circuitry 302 determines whether there is an additional input data to the AI-based model. In response to the adversarial evaluation circuitry 302 determining that there is an additional input data to the AI-based model (block 1136: YES), the machine readable instructions and/or the operations 1100 return to block 1102. In response to the adversarial evaluation circuitry 302 determining that there is no additional input data to the AI-based model (block 1136: NO), the machine readable instructions and/or the operations 1100 terminate.

In the illustrated example of FIG. 11, blocks 1106 and 1108 may be included in or omitted from the machine readable instructions and/or the operations 1100 based on the training approach (e.g., FLOAT, FLOATS, FLOAT slim, FLOATS slim, etc.) with which the AI-based model was trained. For example, blocks 1106 and 1108 may be included in the machine readable instructions and/or the operations 1100 when the AI-based model was trained according to FLOAT slim or FLOATS slim. Alternatively, if the AI-based model was trained according to FLOAT or FLOATS, blocks 1106 and 1108 may be omitted from the machine readable instructions and/or the operations 1100.

FIG. 12 is a block diagram of an example processor platform 1200 structured to execute and/or instantiate the machine readable instructions and/or the operations of FIGS. 9, 10, and/or 11 to implement the machine learning platform 102 of FIGS. 1 and/or 2. In some examples, some or all of the machine readable instructions and/or the operations of FIGS. 9, 10, and/or 11 may be executed and/or instantiated by the processor platform 1200. For example, after an ML model is trained by a remote platform, the remote platform may deploy the machine readable instructions and/or the operations of FIG. 11 to be executed and/or instantiated by the processor platform 1200. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example communication circuitry 202, the example preprocessing circuitry 204, the example parameter adjustment circuitry 208, the example compression control circuitry 210, and/or the example adversarial evaluation circuitry 302, the example parameter tensor control circuitry 304, the example noisy parameter tensor generation circuitry 306, the example convolution circuitry 308, the example normalization circuitry 310, the example output control circuitry, and/or, more generally, the example model execution circuitry 206 of FIGS. 2 and/or 3.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. In this example, the volatile memory 1214 implements the example datastore 212. However, some or all of the datastore 212 may be implemented in the non-volatile memory 1216 and/or the local memory 1213. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with and/or to access data from external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIGS. 9, 10, and/or 11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 9, 10, and/or 11 to effectively instantiate the circuitry of FIGS. 2 and/or 3 as logic circuits to perform the operations corresponding to those machine readable instructions. In some such examples, the circuitry of FIGS. 2 and/or 3 is instantiated by the hardware circuits of the microprocessor 1300 in combination with the instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 9, 10, and/or 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry 1316 (sometimes referred to as arithmetic and logic circuitry), a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control data movement (e.g., coordinate data movement) within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 9, 10, and/or 11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 9, 10, and/or 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 9, 10, and/or 11. As such, the FPGA circuitry 1400 may be structured to effectively instantiate some or all of the machine readable instructions of the flowcharts of FIGS. 9, 10, and/or 11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 9, 10, and/or 11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may be implemented by external hardware circuitry. For example, the external hardware 1406 may be implemented by the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations that may correspond to at least some of the machine readable instructions of FIGS. 9, 10, and/or 11 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 9, 10, and/or 11 may be executed by one or more of the cores 1302 of FIG. 13, a second portion of the machine readable instructions represented by the flowcharts of FIGS. 9, 10, and/or 11 may be executed by the FPGA circuitry 1400 of FIG. 14, and/or a third portion of the machine readable instructions represented by the flowcharts of FIGS. 9, 10, and/or 11 may be executed by an ASIC. It should be understood that some or all of the circuitry of FIGS. 2 and/or 3 may, thus, be instantiated at the same or different times. Some or all of the circuitry may be instantiated, for example, in one or more threads executing concurrently and/or in series. Moreover, in some examples, some or all of the circuitry of FIGS. 2 and/or 3 may be implemented within one or more virtual machines and/or containers executing on the microprocessor.

In some examples, the processor circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

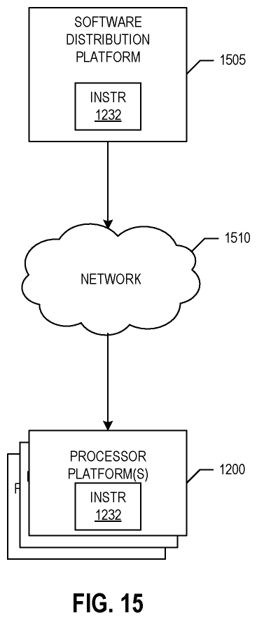

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. For example, in operation the example software distribution platform 1505 is to cause transmission of instructions to devices owned and/or operated by third parties. The third parties may be customers of the entity owning and/or operating the software distribution platform 1505.

In the illustrated example of FIG. 15, the entity that owns and/or operates the software distribution platform 1505 may be, for example, a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions and/or the example operations 900 of FIG. 9, the example machine readable instructions and/or the example operations 912 of FIG. 10, and/or the example machine readable instructions and/or the example operations 1100 of FIG. 11, as described above. The one or more servers of the example software distribution platform 1505 are in communication with an example network 1510, which may correspond to any one or more of the Internet and/or any of the example networks described above (e.g., the example network 106).

In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions and/or the example operations 900 of FIG. 9, the example machine readable instructions and/or the example operations 912 of FIG. 10, and/or the example machine readable instructions and/or the example operations 1100 of FIG. 11, may be downloaded to the example processor platform 1200, which is to execute the machine readable instructions 1232 to implement the machine learning platform 102 of FIGS. 1 and/or 2 and/or the model execution circuitry 206 of FIGS. 2 and/or 3. For example, the instructions, when executed cause processor circuitry of the processor platform 1200 to perform the operations of the machine learning platform 102 of FIGS. 1 and/or 2 and/or the model execution circuitry 206 of FIGS. 2 and/or 3. In this manner, the instructions cause processor circuitry of the processor platform 1200 to perform the operations of the machine learning platform 102 of FIGS. 1 and/or 2 and/or the model execution circuitry 206 of FIGS. 2 and/or 3. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that improve performance of an AI-based model (e.g., a machine learning model) on datasets having different distributions. For example, clean images and adversarial images have different distributions. Example systems, methods, apparatus, and articles of manufacture have been disclosed that do not require additional bottleneck sub-layers, such as FiLM sub-layers. As such, examples disclosed herein reduce training time, reduce the number of trainable parameters, and reduce latency compared to other adversarial training techniques.

Additionally, example training approaches disclosed herein (e.g., FLOAT, FLOATS, FLOAT slim, FLOATS slim, etc.) as disclosed herein generalize better to unseen adversarial attacks. As such, examples training approaches disclosed herein are especially useful for rapidly changing scenarios. Accordingly, example training approaches disclosed herein are particularly useful for training models that are to implemented in edge-based resource constrained applications (e.g., IOT use cases) where robustness to attacks is essential.

Disclosed systems, methods, apparatus, and articles of manufacture improve the efficiency of using a computing device by achieving up to 10% increased RA and up to 6% increased CA over other techniques while requiring significantly less storage for parameters of the model (e.g., up to 400% less) and operating with reduced latency. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve performance of an artificial intelligence based model on datasets having different distributions are disclosed herein. Further examples and combinations thereof include the following:

Example 1 includes an apparatus to, using an artificial intelligence based (AI-based) model, operate on datasets having different distributions, the apparatus comprising interface circuitry to access data, computer readable instructions, and processor circuitry to at least one of instantiate or execute the computer readable instructions to implement adversarial evaluation circuitry to determine whether the data is to be processed as adversarial data, convolution circuitry to, based on whether the adversarial evaluation circuitry indicates that the data is to be processed as the adversarial data, determine a convolution of an input tensor corresponding to the data and (1) a parameter tensor corresponding to a layer of the AI-based model or (2) a noisy parameter tensor generated based on the parameter tensor, and output control circuitry to output a classification of the data based on the convolution.

Example 2 includes the apparatus of example 1, wherein the processor circuitry is to at least one of instantiate or execute the computer readable instructions to implement noisy parameter tensor generation circuitry to, in response to the adversarial evaluation circuitry determining that the data is to be processed as the adversarial data generate a noise tensor, apply at least one of a noise scaling factor or a conditional parameter to the noise tensor, the conditional parameter indicating that the data is to be processed as the adversarial data, and combine the noise tensor with the parameter tensor to generate the noisy parameter tensor.

Example 3 includes the apparatus of example 2, wherein the processor circuitry is to at least one of instantiate or execute the computer readable instructions to implement parameter adjustment circuitry to adjust, based on at least one of a gradient for the parameter tensor or a bitmask tensor for the parameter tensor, at least one of the parameter tensor for the layer of the AI-based model or the noise scaling factor.

Example 4 includes the apparatus of any of examples 2 or 3, wherein to combine the noise tensor with the parameter tensor, the noisy parameter tensor generation circuitry is to perform element-wise addition using first elements of the parameter tensor and second elements of the noise tensor.

Example 5 includes the apparatus of any of examples 1, 2, 3, or 4, wherein the adversarial evaluation circuitry is to determine whether the data is to be processed as the adversarial data based on a conditional parameter.

Example 6 includes the apparatus of any of examples 1, 2, 3, 4, or 5, wherein the processor circuitry is to at least one of instantiate or execute the computer readable instructions to implement preprocessing circuitry to apply a bitmask tensor to the parameter tensor.

Example 7 includes the apparatus of example 6, wherein to apply the bitmask tensor to the parameter tensor, the preprocessing circuitry is to perform element-wise multiplication using first elements of the parameter tensor and second elements of the bitmask tensor.

Example 8 includes the apparatus of any of examples 1, 2, 3, 4, 5, 6 or 7, wherein the layer of the AI-based model is a first layer, the parameter tensor is a first parameter tensor, and the processor circuitry is to at least one of instantiate or execute the computer readable instructions to implement compression control circuitry to determine a ranking of the first layer and a second layer of the AI-based model, based on the ranking and a constraint associated with a total amount of parameters of the AI-based model, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, and update the at least one of the first bitmask tensor or the second bitmask tensor based on the one or more adjustments.

Example 9 includes the apparatus of example 8, wherein the compression control circuitry is to determine the ranking of the first layer and the second layer based on at least one of a first momentum of the first layer and a second momentum of the second layer, or a first Frobenius norm of the first layer and a second Frobenius norm of the second layer.

Example 10 includes the apparatus of any of examples 1, 2, 3, 4, 5, 6, 7, 8, or 9, wherein the processor circuitry is to at least one of instantiate or execute the computer readable instructions to implement parameter tensor control circuitry to adjust the parameter tensor based on a slimming factor for the AI-based model, and normalization circuitry to, in response to the adversarial evaluation circuitry determining that the data is to be processed as the adversarial data, process a tensor output from the convolution circuitry with adversarial normalization for the slimming factor.

Example 11 includes a server to distribute first instructions on a network, the server comprising at least one storage device including second instructions, and processor circuitry to execute the second instructions to cause transmission of the first instructions over the network, the first instructions, when executed, to cause at least one device to determine whether to process data as adversarial data, based on whether the data is to be processed as the adversarial data, compute a convolution of an input tensor corresponding to the data and (1) a parameter tensor associated with a layer of an artificial intelligence based model or (2) a noisy parameter tensor generated based on the parameter tensor, and output a classification of the data based on the convolution.

Example 12 includes the server of example 11, wherein the first instructions, when executed, cause the at least one device to, in response to a determination that the data is to be processed as the adversarial data generate a noise tensor, apply, to the noise tensor, at least one of a noise scaling factor or a conditional parameter, the conditional parameter indicative of whether the data is to be processed as the adversarial data, and generate the noisy parameter tensor as a combination of the noise tensor and the parameter tensor.

Example 13 includes the server of example 12, wherein the at least one storage device includes third instructions, and the processor circuitry is to execute the third instructions to adjust, based on at least one of a gradient for the parameter tensor or a bitmask tensor for the parameter tensor, at least one of the parameter tensor for the layer of the artificial intelligence based model or the noise scaling factor.

Example 14 includes the server of any of examples 12 or 13 wherein the first instructions, when executed, cause the at least one device to generate the noisy parameter tensor by performing element-wise addition using first elements of the parameter tensor and second elements of the noise tensor.

Example 15 includes the server of any of examples 11, 12, 13, or 14, wherein the first instructions, when executed, cause the at least one device to determine whether to process the data as the adversarial data based on a conditional parameter.

Example 16 includes the server of any of examples 11, 12, 13, 14, or 15, wherein the at least one storage device includes third instructions, and the processor circuitry is to execute the third instructions to apply, to the parameter tensor, a bitmask tensor.

Example 17 includes the server of example 16, wherein the third instructions, when executed, cause the processor circuitry to apply, to the parameter tensor, the bitmask tensor by performing element-wise multiplication using first elements of the parameter tensor and second elements of the bitmask tensor.

Example 18 includes the server of any of examples 11, 12, 13, 14, 15, 16, or 17, wherein the layer of the artificial intelligence based (AI-based) model is a first layer, the parameter tensor is a first parameter tensor, the at least one storage device includes third instructions, and the processor circuitry is to execute the third instructions to determine a ranking of the first layer and a second layer of the AI-based model, based on the ranking and a constraint, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, the constraint associated with a total amount of parameters of the AI-based model, and update the at least one of the first bitmask tensor or the second bitmask tensor based on the one or more adjustments.

Example 19 includes the server of example 18, wherein the processor circuitry is to execute the third instructions to determine the ranking of the first layer and the second layer based on at least one of a first momentum of the first layer and a second momentum of the second layer, or a first Frobenius norm of the first layer and a second Frobenius norm of the second layer.

Example 20 includes the server of any of examples 11, 12, 13, 14, 15, 16, 17, 18, or 19, wherein the first instructions, when executed, cause the at least one device to adjust the parameter tensor based on a slimming factor for the artificial intelligence based model, and in response to a determination that the data is to be processed as the adversarial data, process a tensor output from the convolution of the input tensor and the noisy parameter tensor with adversarial normalization for the slimming factor.

Example 21 includes a non-transitory machine readable storage medium comprising instructions that, when executed, cause processor circuitry to at least determine whether to process input data to an artificial intelligence based (AI-based) model as adversarial data, based on whether the input data is to be processed as the adversarial data, determine a convolution of an input tensor corresponding to the input data and (1) a parameter tensor corresponding to a layer of the AI-based model or (2) a noisy parameter tensor corresponding to the parameter tensor, and output a classification of the input data based on the convolution.

Example 22 includes the non-transitory machine readable storage medium of example 21, wherein the instructions cause the processor circuitry to, in response to a determination that the input data is to be processed as the adversarial data generate a noise tensor, apply at least one of a noise scaling factor or a conditional parameter to the noise tensor, the conditional parameter indicating whether the input data is to be processed as the adversarial data, and combine the noise tensor and the parameter tensor to generate the noisy parameter tensor.

Example 23 includes the non-transitory machine readable storage medium of example 22, wherein the instructions cause the processor circuitry to adjust, based on at least one of a gradient for the parameter tensor or a bitmask tensor for the parameter tensor, at least one of the parameter tensor for the layer of the AI-based model or the noise scaling factor.

Example 24 includes the non-transitory machine readable storage medium of any of examples 22 or 23, wherein the instructions cause the processor circuitry to combine the noise tensor and the parameter tensor by performing element-wise addition based on first elements of the parameter tensor and second elements of the noise tensor.

Example 25 includes the non-transitory machine readable storage medium of any of examples 21, 22, 23, or 24, wherein the instructions cause the processor circuitry to determine whether the input data is to be processed as the adversarial data based on a conditional parameter.

Example 26 includes the non-transitory machine readable storage medium of any of examples 21, 22, 23, 24, or 25, wherein the instructions cause the processor circuitry to apply a bitmask tensor to the parameter tensor.

Example 27 includes the non-transitory machine readable storage medium of example 26, wherein the instructions cause the processor circuitry to apply the bitmask tensor to the parameter tensor by performing element-wise multiplication based on first elements of the parameter tensor and second elements of the bitmask tensor.

Example 28 includes the non-transitory machine readable storage medium of any of examples 21, 22, 23, 24, 25, 26, or 27, wherein the layer of the AI-based model is a first layer, the parameter tensor is a first parameter tensor, and the instructions cause the processor circuitry to determine a first rank of the first layer and a second rank of a second layer of the AI-based model, based on the first rank, the second rank, and a constraint associated with a total amount of parameters of the AI-based model, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, and update the at least one of the first bitmask tensor or the second bitmask tensor based on the one or more adjustments.

Example 29 includes the non-transitory machine readable storage medium of example 28, wherein the instructions cause the processor circuitry to determine the first rank of the first layer and the second rank of the second layer based on at least one of a first momentum of the first layer and a second momentum of the second layer, or a first Frobenius norm of the first layer and a second Frobenius norm of the second layer.

Example 30 includes the non-transitory machine readable storage medium of any of examples 21, 22, 23, 24, 25, 26, 27, 28, or 29, wherein the instructions cause the processor circuitry adjust the parameter tensor based on a slimming factor for the AI-based model, and in response to a determination that the input data is to be processed as the adversarial data, process, with adversarial normalization for the slimming factor, a tensor output from the convolution of the input tensor and the noisy parameter tensor.

Example 31 includes a method to, using an artificial intelligence based (AI-based) model, operate on datasets having different distributions, the method comprising determining whether data is to be processed as adversarial data, based on whether the data is to be processed as the adversarial data, convolving an input tensor corresponding to the data with (1) a parameter tensor corresponding to a layer of the AI-based model or (2) a noisy parameter tensor generated based on the parameter tensor, and classifying the data based on the convolving.

Example 32 includes the method of example 31, further including, in response to a determination that the data is to be processed as the adversarial data generating a noise tensor, applying at least one of a noise scaling factor or a conditional parameter to the noise tensor, the conditional parameter indicating that the data is to be processed as the adversarial data, and generating the noisy parameter tensor by combining the noise tensor and the parameter tensor.

Example 33 includes the method of example 32, further including adjusting, based on at least one of a gradient for the parameter tensor or a bitmask tensor for the parameter tensor, at least one of the parameter tensor for the layer of the AI-based model or the noise scaling factor.

Example 34 includes the method of any of examples 32 or 33, further including performing element-wise addition using first elements of the parameter tensor and second elements of the noise tensor to combing the noise tensor and the parameter tensor.

Example 35 includes the method of any of examples 31, 32, 33, or 34, further including determining whether the data is to be processed as the adversarial data based on a conditional parameter.

Example 36 includes the method of any of examples 31, 32, 33, 34, or 35, further including applying a bitmask tensor to the parameter tensor.

Example 37 includes the method of example 36, further including performing element-wise multiplication using first elements of the parameter tensor and second elements of the bitmask tensor to apply the bitmask tensor to the parameter tensor.

Example 38 includes the method of any of examples 31, 32, 33, 34, 35, 36, or 37, wherein the layer of the AI-based model is a first layer, the parameter tensor is a first parameter tensor, and the method further includes ranking the first layer and a second layer of the AI-based model, based on the ranking and a constraint associated with a total amount of parameters of the AI-based model, determining (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, and updating, based on the one or more adjustments, the at least one of the first bitmask tensor or the second bitmask tensor.

Example 39 includes the method of example 38, further including ranking the first layer and the second layer based on at least one of a first momentum of the first layer and a second momentum of the second layer, or a first Frobenius norm of the first layer and a second Frobenius norm of the second layer.

Example 40 includes the method of any of examples 31, 32, 33, 34, 35, 36, 37, 38, or 39, further including adjusting the parameter tensor based on a slimming factor for the AI-based model, and in response to a determination that the data is to be processed as the adversarial data, processing, with adversarial normalization for the slimming factor, a tensor output from the convolving of the input tensor and the noisy parameter tensor.

Example 41 includes an apparatus to, using an artificial intelligence based (AI-based) model, operate on datasets having different distributions, the apparatus comprising means for evaluating whether data is to be processed as adversarial data, means for convolving, based on whether the data is to be processed as the adversarial data, an input tensor corresponding to the data with (1) a parameter tensor corresponding to a layer of the AI-based model or (2) a noisy parameter tensor generated based on the parameter tensor, and means for generating an output including a classification of the data, the classification based on the convolving.

Example 42 includes the apparatus of example 41, further including means for generating the noisy parameter tensor to, in response to a determination that the data is to be processed as the adversarial data generate a noise tensor, apply at least one of a noise scaling factor or a conditional parameter to the noise tensor, the conditional parameter indicating that the data is to be processed as the adversarial data, and combine the noise tensor with the parameter tensor to generate the noisy parameter tensor.

Example 43 includes the apparatus of example 42, further including means for adjusting, based on at least one of a gradient for the parameter tensor or a bitmask tensor for the parameter tensor, at least one of the parameter tensor for the layer of the AI-based model or the noise scaling factor.

Example 44 includes the apparatus of any of examples 42 or 43, wherein to combine the noise tensor with the parameter tensor, the means for generating the noisy parameter tensor is to perform element-wise addition using first elements of the parameter tensor and second elements of the noise tensor.

Example 45 includes the apparatus of any of examples 41, 42, 43, or 44, wherein the means for evaluating whether the data is to be processed as the adversarial data is to evaluate whether the data is to be processed as the adversarial data based on a conditional parameter.

Example 46 includes the apparatus of any of examples 41, 42, 43, 44, or 45, further including means for preprocessing the parameter tensor to apply a bitmask tensor to the parameter tensor.

Example 47 includes the apparatus of example 46, wherein to apply the bitmask tensor to the parameter tensor, the means for preprocessing is to perform element-wise multiplication using first elements of the parameter tensor and second elements of the bitmask tensor.

Example 48 includes the apparatus of any of examples 41, 42, 43, 44, 45, 46, or 47, wherein the layer of the AI-based model is a first layer, the parameter tensor is a first parameter tensor, and the apparatus further includes means for compressing the AI-based model to determine a ranking of the first layer and a second layer of the AI-based model, based on the ranking and a constraint associated with a total amount of parameters of the AI-based model, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, and update the at least one of the first bitmask tensor or the second bitmask tensor based on the one or more adjustments.

Example 49 includes the apparatus of example 48, wherein the means for compressing the AI-based model is to determine the ranking of the first layer and the second layer based on at least one of a first momentum of the first layer and a second momentum of the second layer, or a first Frobenius norm of the first layer and a second Frobenius norm of the second layer.

Example 50 includes the apparatus of any of examples 41, 42, 43, 44, 45, 46, 47, 48, or 49, further including means for controlling the parameter tensor by adjusting the parameter tensor based on a slimming factor for the AI-based model, and means for normalizing a tensor output from the convolving to, in response to a determination that the data is to be processed as the adversarial data, process the parameter tensor with adversarial normalization for the slimming factor.

Example 51 includes an apparatus to, using an artificial intelligence based (AI-based) model, operate on datasets having different distributions, the apparatus comprising at least one datastore to store a parameter tensor corresponding to a layer of the AI-based model, and processor circuitry including one or more of at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus, a Field Programmable Gate Array (FPGA), the FPGA including first logic gate circuitry, a plurality of configurable interconnections, and storage circuitry, the first logic gate circuitry and the plurality of the configurable interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate adversarial evaluation circuitry to determine whether to process input data as adversarial data, convolution circuitry to, based on whether the adversarial evaluation circuitry indicates to process the input data as the adversarial data, determine a convolution of an input tensor corresponding to the input data and (1) the parameter tensor or (2) a noisy parameter tensor generated based on the parameter tensor, and output control circuitry to output a classification of the input data based on the convolution.

Example 52 includes the apparatus of example 51, wherein the processor circuitry is to perform at least one of the first operations, the second operations, or the third operations to instantiate noisy parameter tensor generation circuitry to, in response to the adversarial evaluation circuitry determining that the input data is to be processed as the adversarial data generate a noise tensor, apply, to the noise tensor, at least one of a noise scaling factor or a conditional parameter, the conditional parameter indicative of whether the input data is to be processed as the adversarial data, and combine the noise tensor and the parameter tensor to generate the noisy parameter tensor.

Example 53 includes the apparatus of example 52, wherein the processor circuitry is to perform at least one of the first operations, the second operations, or the third operations to instantiate parameter adjustment circuitry to adjust, based on at least one of a gradient for the parameter tensor or a bitmask tensor for the parameter tensor, at least one of the parameter tensor for the layer of the AI-based model or the noise scaling factor.

Example 54 includes the apparatus of any of examples 52 or 53, wherein the processor circuitry is to perform at least one of the first operations, the second operations, or the third operations to instantiate the noisy parameter tensor generation circuitry to perform element-wise addition using first elements of the parameter tensor and second elements of the noise tensor to combine the noise tensor and the parameter tensor.

Example 55 includes the apparatus of any of examples 51, 52, 53, or 54, wherein the processor circuitry is to perform at least one of the first operations, the second operations, or the third operations to instantiate the adversarial evaluation circuitry to determine whether the input data is to be processed as the adversarial data based on a conditional parameter.

Example 56 includes the apparatus of any of examples 51, 52, 53, 54, or 55, wherein the processor circuitry is to perform at least one of the first operations, the second operations, or the third operations to instantiate preprocessing circuitry to apply a bitmask tensor to the parameter tensor.

Example 57 includes the apparatus of example 56, wherein the processor circuitry is to perform at least one of the first operations, the second operations, or the third operations to instantiate the preprocessing circuitry to perform element-wise multiplication using first elements of the parameter tensor and second elements of the bitmask tensor to apply the bitmask tensor to the parameter tensor.

Example 58 includes the apparatus of any of examples 51, 52, 53, 54, 55, 56, or 57, wherein the layer of the AI-based model is a first layer, the parameter tensor is a first parameter tensor, and the processor circuitry is to perform at least one of the first operations, the second operations, or the third operations to instantiate compression control circuitry to rank the first layer and a second layer of the AI-based model, based on a first rank of the first layer, a second rank of the second layer, and a constraint associated with a total amount of parameters of the AI-based model, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, and update the at least one of the first bitmask tensor or the second bitmask tensor based on the one or more adjustments.

Example 59 includes the apparatus of example 58, wherein the processor circuitry is to perform at least one of the first operations, the second operations, or the third operations to instantiate the compression control circuitry to rank the first layer and the second layer based on at least one of a first momentum of the first layer and a second momentum of the second layer, or a first Frobenius norm of the first layer and a second Frobenius norm of the second layer.

Example 60 includes the apparatus of any of examples 51, 52, 53, 54, 55, 56, 57, 58, or 59, wherein the processor circuitry is to perform at least one of the first operations, the second operations, or the third operations to instantiate parameter tensor control circuitry to adjust the parameter tensor based on a slimming factor for the AI-based model, and normalization circuitry to, in response to the adversarial evaluation circuitry determining that the input data is to be processed as the adversarial data, process a tensor output from the convolution circuitry with adversarial normalization for the slimming factor.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to, using an artificial intelligence based (AI-based) model, operate on datasets having different distributions, the apparatus comprising:
interface circuitry to access data;
computer readable instructions; and
processor circuitry to at least one of instantiate or execute the computer readable instructions to implement:
adversarial evaluation circuitry to determine whether the data is to be processed as adversarial data;
convolution circuitry to, based on whether the adversarial evaluation circuitry indicates that the data is to be processed as the adversarial data, determine a convolution of an input tensor corresponding to the data and (1) a parameter tensor corresponding to a layer of the AI-based model or (2) a noisy parameter tensor generated based on the parameter tensor; and
output control circuitry to output a classification of the data based on the convolution.

2. The apparatus of claim 1, wherein the processor circuitry is to at least one of instantiate or execute the computer readable instructions to implement noisy parameter tensor generation circuitry to, in response to the adversarial evaluation circuitry determining that the data is to be processed as the adversarial data:
generate a noise tensor;
apply at least one of a noise scaling factor or a conditional parameter to the noise tensor, the conditional parameter indicating that the data is to be processed as the adversarial data; and
combine the noise tensor with the parameter tensor to generate the noisy parameter tensor.

3. The apparatus of claim 2, wherein the processor circuitry is to at least one of instantiate or execute the computer readable instructions to implement parameter adjustment circuitry to adjust, based on at least one of a gradient for the parameter tensor or a bitmask tensor for the parameter tensor, at least one of the parameter tensor for the layer of the AI-based model or the noise scaling factor.

4. The apparatus of claim 2, wherein to combine the noise tensor with the parameter tensor, the noisy parameter tensor generation circuitry is to perform element-wise addition using first elements of the parameter tensor and second elements of the noise tensor.

5. The apparatus of claim 1, wherein the adversarial evaluation circuitry is to determine whether the data is to be processed as the adversarial data based on a conditional parameter.

6. The apparatus of claim 1, wherein the processor circuitry is to at least one of instantiate or execute the computer readable instructions to implement preprocessing circuitry to apply a bitmask tensor to the parameter tensor.

7. The apparatus of claim 6, wherein to apply the bitmask tensor to the parameter tensor, the preprocessing circuitry is to perform element-wise multiplication using first elements of the parameter tensor and second elements of the bitmask tensor.

8. The apparatus of claim 1, wherein the layer of the AI-based model is a first layer, the parameter tensor is a first parameter tensor, and the processor circuitry is to at least one of instantiate or execute the computer readable instructions to implement compression control circuitry to:
determine a ranking of the first layer and a second layer of the AI-based model;
based on the ranking and a constraint associated with a total amount of parameters of the AI-based model, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted; and
update the at least one of the first bitmask tensor or the second bitmask tensor based on the one or more adjustments.

9. The apparatus of claim 8, wherein the compression control circuitry is to determine the ranking of the first layer and the second layer based on at least one of:
a first momentum of the first layer and a second momentum of the second layer; or
a first Frobenius norm of the first layer and a second Frobenius norm of the second layer.

10. The apparatus of claim 1, wherein the processor circuitry is to at least one of instantiate or execute the computer readable instructions to implement:
parameter tensor control circuitry to adjust the parameter tensor based on a slimming factor for the AI-based model; and
normalization circuitry to, in response to the adversarial evaluation circuitry determining that the data is to be processed as the adversarial data, process a tensor output from the convolution circuitry with adversarial normalization for the slimming factor.

11. A server to distribute first instructions on a network, the server comprising:
at least one storage device including second instructions; and
processor circuitry to execute the second instructions to cause transmission of the first instructions over the network, the first instructions, when executed, to cause at least one device to:
determine whether to process data as adversarial data;
based on whether the data is to be processed as the adversarial data, compute a convolution of an input tensor corresponding to the data and (1) a parameter tensor associated with a layer of an artificial intelligence based model or (2) a noisy parameter tensor generated based on the parameter tensor; and
output a classification of the data based on the convolution.

12. The server of claim 11, wherein the first instructions, when executed, cause the at least one device to, in response to a determination that the data is to be processed as the adversarial data:
generate a noise tensor;
apply, to the noise tensor, at least one of a noise scaling factor or a conditional parameter, the conditional parameter indicative of whether the data is to be processed as the adversarial data; and
generate the noisy parameter tensor as a combination of the noise tensor and the parameter tensor.

13. The server of claim 12, wherein the at least one storage device includes third instructions, and the processor circuitry is to execute the third instructions to adjust, based on at least one of a gradient for the parameter tensor or a bitmask tensor for the parameter tensor, at least one of the parameter tensor for the layer of the artificial intelligence based model or the noise scaling factor.

14. The server of claim 12, wherein the first instructions, when executed, cause the at least one device to generate the noisy parameter tensor by performing element-wise addition using first elements of the parameter tensor and second elements of the noise tensor.

15. The server of claim 11, wherein the first instructions, when executed, cause the at least one device to determine whether to process the data as the adversarial data based on a conditional parameter.

16. The server of claim 11, wherein the at least one storage device includes third instructions, and the processor circuitry is to execute the third instructions to apply, to the parameter tensor, a bitmask tensor.

17. The server of claim 16, wherein the third instructions, when executed, cause the processor circuitry to apply, to the parameter tensor, the bitmask tensor by performing element-wise multiplication using first elements of the parameter tensor and second elements of the bitmask tensor.

18. The server of claim 11, wherein the layer of the artificial intelligence based (AI-based) model is a first layer, the parameter tensor is a first parameter tensor, the at least one storage device includes third instructions, and the processor circuitry is to execute the third instructions to:
determine a ranking of the first layer and a second layer of the AI-based model;
based on the ranking and a constraint, determine (1) that at least one of a first bitmask tensor corresponding to the first parameter tensor or a second bitmask tensor corresponding to a second parameter tensor is to be adjusted, the second parameter tensor corresponding to the second layer and (2) one or more adjustments to the at least one of the first bitmask tensor or the second bitmask tensor that is to be adjusted, the constraint associated with a total amount of parameters of the AI-based model; and
update the at least one of the first bitmask tensor or the second bitmask tensor based on the one or more adjustments.

19. The server of claim 18, wherein the processor circuitry is to execute the third instructions to determine the ranking of the first layer and the second layer based on at least one of:
a first momentum of the first layer and a second momentum of the second layer; or
a first Frobenius norm of the first layer and a second Frobenius norm of the second layer.

20. The server of claim 11, wherein the first instructions, when executed, cause the at least one device to:
adjust the parameter tensor based on a slimming factor for the artificial intelligence based model; and
in response to a determination that the data is to be processed as the adversarial data, process a tensor output from the convolution of the input tensor and the noisy parameter tensor with adversarial normalization for the slimming factor.

21. A non-transitory machine readable storage medium comprising instructions that, when executed, cause processor circuitry to at least:
determine whether to process input data to an artificial intelligence based (AI-based) model as adversarial data;
based on whether the input data is to be processed as the adversarial data, determine a convolution of an input tensor corresponding to the input data and (1) a parameter tensor corresponding to a layer of the AI-based model or (2) a noisy parameter tensor corresponding to the parameter tensor; and
output a classification of the input data based on the convolution.

22. The non-transitory machine readable storage medium of claim 21, wherein the instructions cause the processor circuitry to, in response to a determination that the input data is to be processed as the adversarial data:
generate a noise tensor;
apply at least one of a noise scaling factor or a conditional parameter to the noise tensor, the conditional parameter indicating whether the input data is to be processed as the adversarial data; and
combine the noise tensor and the parameter tensor to generate the noisy parameter tensor.

23. The non-transitory machine readable storage medium of claim 22, wherein the instructions cause the processor circuitry to adjust, based on at least one of a gradient for the parameter tensor or a bitmask tensor for the parameter tensor, at least one of the parameter tensor for the layer of the AI-based model or the noise scaling factor.

24. The non-transitory machine readable storage medium of claim 22, wherein the instructions cause the processor circuitry to combine the noise tensor and the parameter tensor by performing element-wise addition based on first elements of the parameter tensor and second elements of the noise tensor.

25. The non-transitory machine readable storage medium of claim 21, wherein the instructions cause the processor circuitry to determine whether the input data is to be processed as the adversarial data based on a conditional parameter.

26.-60. (canceled)
